(19) United States
(12) Patent Application Publication
(10) Pub. No.: US 2025/0128925 A1
(43) Pub. Date: Apr. 24, 2025

(54) AUTONOMOUS MOBILE ROBOT OPERATIONS FOR LAST ROWS IN-TRAILER LOADING

(71) Applicant: Gideon Brothers d.o.o., Osijek (HR)

(72) Inventors: Daniel Guja, Dugo Selo (HR); Kruno Lenac, Zagreb (HR); Tomislav Haus, Stubica (HR); Josip Cesic, Zagreb (HR)

(21) Appl. No.: 18/919,240

(22) Filed: Oct. 17, 2024

Related U.S. Application Data
(60) Provisional application No. 63/591,386, filed on Oct. 18, 2023.

(51) Int. Cl. B66F 9/06; B66F 9/075; B66F 9/24

(52) U.S. Cl. CPC B66F 9/063; B66F 9/0755; B66F 9/24

(57) ABSTRACT

Loading last few rows of pallets onto a trailer using an autonomous mobile robot. The robot determines that the next pallet to be loaded is a first in a row where the trailer does not have sufficient space to accommodate the robot. The robot identifies a pose of a previous pallet in an immediately prior row and determines a front plane of the immediately prior row. The robot navigates to a first goal position at least partially inside the trailer, determined by the pose of the previous pallet and the trailer. The robot then side-shifts the fork toward the trailer's side wall until contact is detected and subsequently adjust the fork back to prevent scraping. The robot proceeds to a second goal position, which is within a predetermined threshold distance of the drop position, before lowering and releasing the pallet.

### CROSS-REFERENCE TO RELATED APPLICATIONS

This application claims the benefit of U.S. Provisional Patent Application No. 63/591,386, filed Oct. 18, 2023, which is incorporated by reference in its entirety.

### BACKGROUND

An autonomous mobile robot, such as an autonomous forklift, is a robot that is capable of autonomously navigating an environment (e.g., a warehouse environment) and manipulating objects within that environment. However, these robots have difficulty with placing pallets in confined spaces.

For instance, trailers offer limited room, requiring precise pallet placement to avoid collisions with trailer walls, door edges, or other nearby pallets. The most common approach for placing pallets in trailers still involves using standard forklifts operated by skilled workers. Human operators must manually align the forklift forks with the pallet and maneuver within the tight confines of the trailer. This method depends heavily on the operator's experience and skill to avoid collisions with trailer walls, pallets, and other obstacles.

### SUMMARY

Embodiments described herein address the above-described challenge by enabling an autonomous mobile robot to side-shift pallets inside a trailer and using sensors to detect contact and boundaries of environment.

In some embodiments, an autonomous mobile robot carrying a pallet on its fork determines the pose of a trailer relative to a facility's pose and navigates to a drop position inside the trailer. The robot side-shifts its fork toward the trailer wall until its sensors detect contact between the lateral side of the pallet and the wall. The trailer wall has a lip along its bottom side. At this point, a lip on the trailer wall is positioned beneath the pallet. The robot then side-shifts the fork away from the wall by a distance corresponding to the width of the lip and drops the pallet at the drop position once it is determined that the robot is within a predetermined threshold distance from the drop position.

When loading the last few rows, the trailer does not have enough space to fully accommodate the autonomous mobile robot. Due to space constraints, the robot is configured to align the side of the pallet with the side wall of the trailer as late as possible before executing the straight-line movement to drop the pallet inside the trailer. In such cases, the robot determines the pose of a previous pallet in the row immediately prior and establishes a front plane based on this pallet's pose. The robot navigates to a first goal position that is at least partially inside the trailer, with the position determined by the pose of the previous pallet and the trailer. The robot side-shifts the fork back and forth to align the side of the pallet with the trailer wall, ensuring minimum clearance, then moves straight forward from the first goal position to a second goal position that is within a predetermined threshold distance of the drop position.

The autonomous mobile robot is also capable of unloading pallets from a trailer to a staging area. The robot first determines the pose of the trailer and the pose of each observable pallet within it. Based on these poses, the robot selects a target pallet to unload. It also identifies the front plane of the pallets in the same row as the target pallet, with the front plane being the plane of the pallet closest to the trailer entrance. The robot navigates to a first goal position within the trailer, which is determined by the poses of the target pallet and the trailer. The robot then side-shifts its fork to align with the pallet's fork pockets, inserts the forks into the pockets, lifts the pallet, and navigates straight backward from the first goal position to a second goal position. This second goal position is determined based on the front plane of the pallets in the same row and the trailer's pose. The robot then moves from the second goal position in the trailer to a drop-off point in the staging area, side-shifting the fork toward the center as it proceeds.

Similar to loading, when unloading the first few rows, the trailer may not have sufficient space to fully accommodate the autonomous mobile robot. Also due to the space constraint, the initial straight line pulling out process cannot avoid the trailer door or seal, which reduces the margin for error. In these scenarios, the robot identifies the first pallet in a row where this space limitation exists. It determines the pose of each observable pallet in the trailer and identifies the front plane of the pallets in the same row as the first pallet, with the front plane being the plane of the pallet closest to the trailer entrance. The robot navigates to a first goal position that is at least partially inside the trailer, based on the poses of the first pallet and the trailer. The robot then picks up the first pallet with its fork, side-shifts the fork toward an adjacent second pallet in the same row, and then side-shifts back by a predetermined distance to maximize clearance between the first pallet and the trailer wall. The robot navigates straight backward from the first goal position to a second goal position located on a ramp between the trailer and the staging area. The second goal position is determined based on the front plane of the pallets in the same row and the trailer's pose, and the robot then moves from the second goal position to a drop-off position in the staging area.

### BRIEF DESCRIPTION OF THE DRAWINGS

Figure (FIG.) 1 illustrates an environment for operating an autonomous mobile robot using a central communication system, in accordance with some embodiments.

FIG. 2 illustrates exemplary modules and data stores used by a central communication system, in accordance with some embodiments.

FIG. 3 illustrates exemplary modules and data stores used by the autonomous mobile robot, in accordance with some embodiments.

FIG. 4 illustrates an example autonomous mobile robot navigating through a warehouse environment to a trailer, in accordance with some embodiments.

FIG. 5A illustrates example characteristics that the autonomous mobile robot may determine based on sensor data, in accordance with some embodiments.

FIG. 5B illustrates example locations of the autonomous mobile robot and objects within the trailer, as determined by the autonomous mobile robot, in accordance with some embodiments.

FIG. 6A illustrates an autonomous mobile robot approaching a ramp that leads from the warehouse to the trailer, in accordance with some embodiments.

FIG. 6B illustrates an autonomous mobile robot attempting to unload an object in the last row of the trailer without adjusting its forklift, in accordance with some embodiments.

FIG. 6C illustrates an autonomous mobile robot that adjusts its forklift to be level with the floor of the trailer, in accordance with some embodiments.

FIG. 7 illustrates an example autonomous mobile robot that uses a centerline heuristic to navigate within a trailer, in accordance with some embodiments.

FIG. 8 illustrates an example environment in which an autonomous mobile robot loads pallets from a staging area onto a trailer, in accordance with some embodiments.

FIG. 9 illustrates a cross-sectional view of a trailer where the trailer includes wall lips along the bottom of two side walls, in accordance with some embodiments.

FIG. 10 illustrates an example trailer in which a front plane of a previous row of pallet is determined, in accordance with some embodiments.

FIG. 11 illustrates examples of different positionings fork at different locations relative to pallet pockets, in accordance with one or more embodiments.

FIG. 12 illustrates an example environment in which an autonomous mobile robot unloads pallets from a trailer onto a staging area, in accordance with some embodiments.

FIG. 13 illustrates an example environment, in which a pallet in one of the first X rows is to be unloaded, in accordance with one or more embodiments.

FIG. 14 illustrates an example trailer, in which a target pallet overlaps a pallet in a previous row, in accordance with some embodiments.

FIG. 15 is a flowchart of an example method for loading pallets from a staging area into a trailer, in accordance with some embodiments.

FIG. 16 is a flowchart of an example method for loading last X rows of pallets onto a trailer, in accordance with some embodiments.

FIG. 17 is a flowchart of an example method for unloading pallets from a trailer to a staging area, in accordance with some embodiments.

FIG. 18 is a flowchart of an example method for unloading first X rows of pallets from a trailer to a staging area, in accordance with some embodiments.

### DETAILED DESCRIPTION

Autonomous mobile robots can be utilized for load handling tasks and are equipped with load handling mechanisms to carry out these tasks. For example, some autonomous mobile robots may feature load handling systems, such as forks, designed to lift, carry, and transport loads like pallets, crates, or containers. However, challenges arise when loading and unloading pallets from a trailer due to the fixed and confined interior space of the trailer, which restricts the autonomous mobile robot's (or any forklift's) ability to maneuver freely.

The embodiments described herein address the aforementioned challenge by enabling the robot to perform side-shifting of pallets. Side-shifting allows the fork to move left or right, relative to its default centered position, without requiring the entire robot to move. This enables the fork, along with any load it carries, to shift laterally. Additionally, the robot can detect front and side contact using direct sensor measurements, such as distance or force sensors, or through indirect measurements like pallet movement on the forks or motor current spikes. Moreover, when loading the last few rows or unloading the first few rows, there may not be sufficient space to fully accommodate the robot inside the trailer. Embodiments described herein using sensors to enable the robot to precisely position and side-shift pallets while part of the robot or pallet remains outside the trailer.

Additional details about the autonomous mobile robots are further described below with respect to FIGS. 1-18.

### System Environment

Figure (FIG.) 1 illustrates an environment for operating an autonomous mobile robot using a central communication system, in accordance with some embodiments. Environment 100 includes operator device 110, network 120, central communication system 130, and autonomous mobile robot 140. Environment 100 may be generally described herein as a warehouse environment, however, environment 100 may be any kind of environment. Environment 100 need not be limited to a defined space (e.g., an interior of a warehouse), and may include any areas that are within the purview of instructions of an autonomous mobile robot (e.g., parking lots, loading docks, and so on that are outside of a warehouse space). While operator device 110 and central communication system 130 are depicted as being within environment 100, this is merely for convenience; these devices may be located outside of environment 100 (e.g., at a home, office, data center, cloud environment, etc.). Additional embodiments may include more, fewer, or different components from those illustrated in FIG. 1, and the functionality of each component may be divided between the components differently from the description below. Additionally, each component may perform their respective functionalities in response to a request from a human, or automatically without human intervention.

Operator device 110 may be any client device that interfaces one or more human operators with one or more autonomous mobile robots of environment 100 and/or central communication system 130. Exemplary client devices include smartphones, tablets, personal computers, kiosks, and so on. While only one operator device 110 is depicted, this is merely for convenience, and a human operator may use any number of operator devices to interface with autonomous mobile robots 140 or the central communication system 130. Operator device 110 may have a dedicated application installed thereon (e.g., downloaded from central communication system 130) for interfacing with the autonomous mobile robot 140 or the central communication system 130. Alternatively, or additionally, operator device 110 may access such an application by way of a browser. References to operator device 110 in the singular are done for convenience only, and equally apply to a plurality of operator devices.

Network 120 may be any network suitable for connecting operator device 110 with central communication system 130 and/or autonomous mobile robot 140. Exemplary networks may include a local area network, a wide area network, the Internet, an ad hoc network, and so on. In some embodiments, network 120 may be a closed network that is not connected to the Internet (e.g., to heighten security and prevent external parties from interacting with central communication system 130 and/or autonomous mobile robot 140). Such embodiments may be particularly advantageous where client device 110 is within the boundaries of environment 100.

Central communication system 130 acts as a central controller for a fleet of one or more robots including autonomous mobile robot 140. Central communication system 130 receives information from the fleet or the operator device 110 and uses that information to make decisions about activity to be performed by the fleet. Central communication system 130 may be installed on one device, or may be distributed across multiple devices. Central communication system 130 may be located within environment 100 or may be located outside of environment 100 (e.g., in a cloud implementation).

Autonomous mobile robot 140 may be any robot configured to act autonomously with respect to a command. For example, an autonomous mobile robot 140 may be commanded to move an object from a source area to a destination area, and may be configured to make decisions autonomously as to how to optimally perform this function (e.g., which side to lift the object from, which path to take, and so on). Autonomous mobile robot 140 may be any robot suitable for performing a commanded function. Exemplary autonomous mobile robots include vehicles, such as forklifts, mobile storage containers, etc. References to autonomous mobile robot 140 in the singular are made for convenience and are non-limiting; these references equally apply to scenarios including multiple autonomous mobile robots.

### Exemplary Central Communication System Configuration

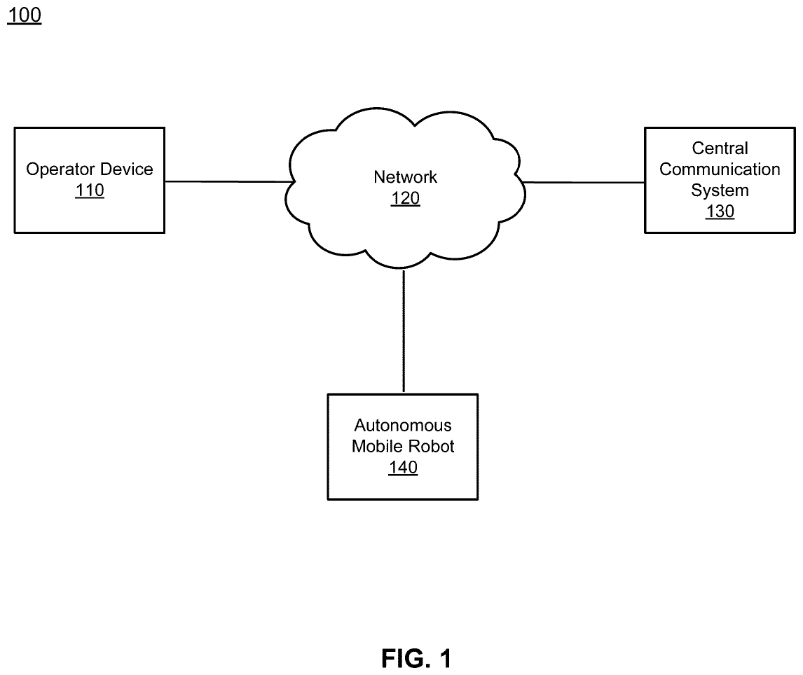

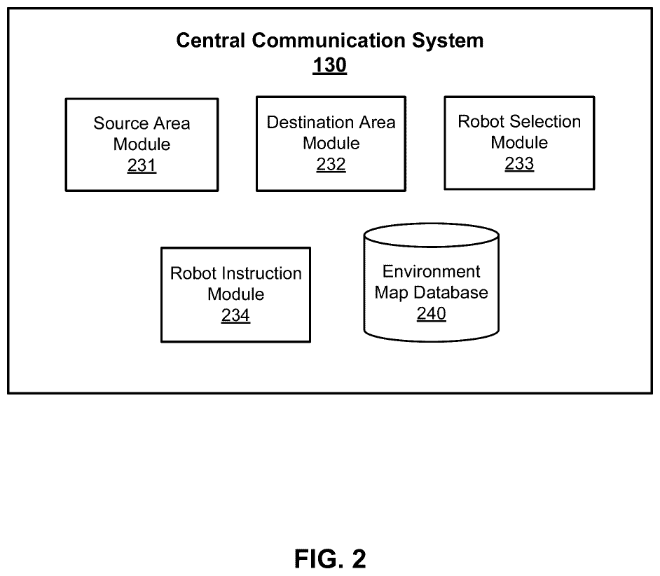

FIG. 2 illustrates exemplary modules and data stores used by the central communication system 130, in accordance with some embodiments. The central communication system 130 may include a source area module 231, a destination area module 232, a robot selection module 233, and a robot instruction module 234, as well as an environment map database 240. The modules and databases depicted in FIG. 2 are merely exemplary; fewer or more modules and/or databases may be used by central communication system 130 to achieve the functionality disclosed herein. Additionally, the functionality of each component may be divided between the components differently from the description below. Additionally, each component may perform their respective functionalities in response to a request from a human, or automatically without human intervention.

The source area module 231 identifies a source area. The term source area, as used herein, may refer to either a single point, several points, or a region surrounded by a boundary (sometimes referred to herein as a source boundary) within which a robot is to manipulate objects (e.g., pick up objects for transfer to another area). In an embodiment, the source area module 231 receives input from operator device 110 that defines the point(s) and/or region that form the source area. In an embodiment, the source area module 231 may receive input from one or more robots (e.g., image and/or depth sensor information showing objects known to need to be moved (e.g., within a predefined load dock)), and may automatically determine a source area to include a region within a boundary that surrounds the detected objects. The source area may change dynamically as objects are manipulated (e.g., the source area module 232 may shrink the size of the source area by moving boundaries inward as objects are transported out of the source area, and/or may increase the size of the source area by moving boundaries outward as new objects are detected).

The destination area module 232 identifies a destination area. The term destination area, as used herein, may refer to either a single point, several points, or a region surrounded by a boundary (sometimes referred to herein as a destination boundary) within which a robot is to manipulate objects (e.g., drop an object off to rest). For example, where the objects are pallets in a warehouse setting, the destination area may include several pallet stands at different points in the facility, any of which may be used to drop off a pallet. The destination area module 232 may identify the destination area in any manner described above with respect to a source area, and may also identify the destination area using additional means.

The destination area module 232 may determine the destination area based on information about the source area and/or the objects to be transported. Objects in the source area may have certain associated rules that add constraints to the destination area. For example, there may be a requirement that the objects be placed in a space having a predefined property (e.g., a pallet must be placed on a pallet stand, and thus the destination area must have a pallet stand for each pallet to be moved). As another example, there may be a requirement that the objects be placed at least a threshold distance away from the destination area boundary, and thus, destination area module 232 may require a human draw the boundary at least at this distance and/or may populate the destination boundary automatically according to this rule (and thus, the boundary must be drawn at least that distance away). Yet further, destination area module 232 may require that the volume of the destination area is at least large enough to accommodate all of the objects to be transported that are initially within the source area.

Source area module 231 and destination area module 232 may, in addition to, or alternative to, using rules to determine their respective boundaries, may use machine learning models to determine their respective boundaries. The models may be trained to take information as input, such as some or all of the above-mentioned constraints, sensory data, map data, object detection data, and so on, and to output boundaries based thereon. The models may be trained using data on tasks assigned to robots in the past, such as data on how operators have defined or refined the tasks based on various parameters and constraints.

Robot selection module 233 selects one or more robots that are to transport objects from the source area to the destination area. In an embodiment, robot selection module 233 performs this selection based on one or more of a manipulation capability of the robots and a location of the robots within the facility. The term manipulation capability, as used herein, refers to a robot's ability to perform a task related to manipulation of an object. For example, if an object must be lifted, the robot must have the manipulation capability to lift objects, to lift an object having at least the weight of the given object to be lifted, and so on. Other manipulation capabilities may include an ability to push an object, an ability to drive an object (e.g., a mechanical arm may have an ability to lift an object, but may be unable to drive an object because it is affixed to, e.g., the ground), and so on. Further manipulation capabilities may include lifting and then transporting objects, hooking and then towing objects, tunneling and then transporting objects, using robots in combination with one another (e.g., an arm or other manipulates an object (e.g., lifts), places on another robot, and the robot then drives to the destination with the object). These examples are merely exemplary and non-exhaustive. Robot selection module 233 may determine required manipulation capabilities to manipulate the object(s) at issue, and may select one or more robots that satisfy those manipulation capabilities.

In terms of location, robot selection module 233 may select one or more robots based on their location to the source area and/or the destination area. For example, robot selection module 233 may determine one or more robots that are closest to the source area, and may select those robot(s) to manipulate the object(s) in the source area. Robot selection module 233 may select the robot(s) based on additional factors, such as a number of objects to be manipulated, manipulation capabilities of the robot (e.g., how many objects can the robot carry at once; sensors the robot is equipped with; etc.), motion capabilities of the robot, and so on. In an embodiment, robot selection module 233 may select robots based on a state of one or more robot's battery (e.g., a closer robot may be passed up for a further robot because the closer robot has insufficient battery to complete the task). In an embodiment, robot selection module 233 may select robots based on their internal health status (e.g., where a robot is reporting an internal temperature close to overheating, that robot may be passed up even if it otherwise optimal, to allow that robot to cool down). Other internal health status parameters may include battery or fuel levels, maintenance status, and so on. Yet further factors may include future orders, a scheduling strategy that incorporates a longer horizon window (e.g., a robot that is optimal to be used now may, if used now, result in inefficiencies (e.g., depleted battery level or sub-optimal location), given a future task for that robot), a scheduling strategy that incorporates external processes, a scheduling strategy that results from information exchanged between higher level systems (e.g., WMS, ERP, EMS, etc.), and so on.

The robot selection module 233 may select a robot using machine learning model trained to take various parameters as input, and to output one or more robots best suited to the task. The inputs may include available robots, their manipulation capabilities, their locations, their state of health, their availability, task parameters, scheduling parameters, map information, and/or any other mentioned attributes of robots and/or tasks. The outputs may include an identification of one or more robots to be used (or suitable to be used) to execute a task. The robot selection module 233 may automatically select one or more of the identified robots for executing a task, or may prompt a user of operator device 110 to select from the identified one or more robots.

The robot instruction module 234 transmits instructions to the selected one or more robots to manipulate the object(s) in the source area (e.g., to ultimately transport the object(s) to the destination area). In an embodiment, the robot instruction module 234 includes detailed step-by-step instructions on how to transport the objects. In another embodiment, the robot instruction module 234 transmits a general instruction to transmit one or more objects from the source area to the destination area, leaving the manner in which the objects will be manipulated and ultimately transmitted up to the robot to determine autonomously.

The robot instruction module 234 may transmit instructions to a robot to traverse from a start pose to an end pose. In some embodiments, the robot instruction module 234 simply transmits a start pose and end pose to the robot and the robot determines a path from the start pose to the end pose. Alternatively, the robot instruction module 234 may provide some information on a path the robot should take to travel from the start pose to the end pose. Robot pathfinding is discussed in more detail below.

Environment map database 240 stores information about the environment of the autonomous mobile robot 140. The environment of an autonomous mobile robot 140 is the area within which the autonomous mobile robot 140 operates. For example, the environment may be a facility or a parking lot within which the autonomous mobile robot 140 operates. In some embodiments, the environment map database 240 stores environment information in one or more maps representative of the environment. The maps may be two-dimensional, three dimensional, or a combination of both. Central communication system 130 may receive a map from operator device 110, or may generate one based on input received from one or more robots 140 (e.g., by stitching together images and/or depth information received from the robots as they traverse the facility, and optionally stitching in semantic, instance, and/or other sensor-derived information into corresponding portions of the map). In some embodiments, the map stored by the environment map database 240 indicates the locations of obstacles within the environment. The map may include information about each obstacle, such as whether the obstacle is an animate or inanimate object.

Environment map database 240 may be updated by central communication system 130 based on information received from the operator device 110 or from the robots 140. Information may include images, depth information, auxiliary information, semantic information, instance information, and any other information described herein. The environment information may include information about objects within the facility, obstacles within the facility, and auxiliary information describing activity in the facility. Auxiliary information may include traffic information (e.g., a rate at which humans and/or robots access a given path or area within the facility), information about the robots within the facility (e.g., manipulation capability, location, etc.), time-of-day information (e.g., traffic as it is expected during different segments of the day), and so on.

The central communication system 130 may continuously update environment information stored by the environment map database 240 as such information is received (e.g., to show a change in traffic patterns on a given path). The central communication system 130 may also update environment information responsive to input received from the operator device 110 (e.g., manually inputting an indication of a change in traffic pattern, an area where humans and/or robots are prohibited, an indication of a new obstacle, and so on).

### Exemplary Autonomous Mobile Robot Configuration

FIG. 3 illustrates exemplary modules and data stores used by the autonomous mobile robot, in accordance with some embodiments. As depicted in FIG. 3, autonomous mobile robot 140 includes a robot sensor module 331, an object identification module 332, a robot movement module 333, a robot navigation module 334, a load handling mechanism 335 and a controller 336. The modules and databases depicted in FIG. 3 are merely exemplary; fewer or more modules and/or databases may be used to achieve the functionality described herein. Furthermore, any of the described functionality of the modules may instead be performed by the central communication system 130 or the operator device 110. Additionally, any of the functionality of these modules may be performed with or without human instruction.

The robot sensor module 331 includes a number of sensors that the robot uses to collect data about the robot's surroundings. For example, the robot sensor module 331 may include one or more cameras, one or more depth sensors, one or more scan sensors (e.g., RFID), a location sensor (e.g., showing location of the robot within the facility and/or GPS coordinates), and so on. Additionally, the robot sensor module 331 may include software elements for preprocessing sensor data for use by the robot. For example, the robot sensor module 331 may generate depth data information based on LIDAR sensor data. Data collected by the robot sensor module 331 may be used by the object identification module 332 to identify obstacles around the robot or may be used to determine a pose into which the robot must travel to reach an end pose.

The object identification module 332 ingests information received from the robot sensor module 331, and outputs information that identifies an object in proximity to the robot. The object identification module 332 may utilize information from a map of the facility (e.g., as retrieved from environment map database 240) in addition to information from the robot sensor module 331 in identifying the object. For example, the object identification module 332 may utilize location information, semantic information, instance information, and so on to identify the object.

Additionally, the object identification module 332 identifies obstacles around the robot for the robot to avoid. For example, the object identification module 332 determines whether an obstacle is an inanimate obstacle (e.g., a box, a plant, or a column) or an animate object (e.g., a person or an animal). The object identification module 332 may use information from the environment map database 240 to determine where obstacles are within the robot's environment. Similarly, the object identification module 332 may use information from the robot sensor module 331 to identify obstacles around the robot.

The robot movement module 333 transports the robot within its environment. For example, the robot movement module 333 may include a motor, wheels, tracks, and/or legs for moving. The robot movement module 333 may include components that the robot uses to move from one pose to another pose. For example, the robot may use components in the robot movement module 333 to change its x-, y-, or z-coordinates or to change its orientation. In some embodiments, the robot movement module 333 receives instructions from the robot navigation module 334 to follow a path determined by the robot navigation module 334 and performs the necessary actions to transport the robot along the determined path.

The robot navigation module 334 determines a path for the robot from a start pose to an end pose within the environment. A pose of the robot may refer to an orientation of the robot and/or a location of the robot (including x-, y-, and z-coordinates). The start pose may be the robot's current pose or some other pose within the environment. The end pose may be an ultimate pose within the environment to which the robot is traveling or may be an intermediate pose between the ultimate pose and the start pose. The path may include a series of instructions for the robot to perform to reach the goal pose. For example, the path may include instructions for the robot to travel from one x-, y-, or z-coordinate to another and/or to adjust the robot's orientation (e.g., by taking a turn or by rotating in place). In some embodiments, the robot navigation module 334 implements routing instructions received by the robot from the central communication system 130. For example, the central communication system 130 may transmit an end pose to the robot navigation module 334 or a general path for the robot to take to a goal pose, and the robot navigation module 334 may determine a path that avoids objects, obstacles, or people within the environment. The robot navigation module 334 may determine a path for the robot based on sensor data or based on environment data. In some embodiments, the robot navigation module 334 updates an already determined path based on new data received by the robot.

In some embodiments, the robot navigation module 334 receives an end location and the robot navigation module 334 determines an orientation of the robot necessary to perform a task at the end location. For example, the robot may receive an end location and an instruction to deliver an object at the end location, and the robot navigation module 334 may determine an orientation that the robot must take to properly deliver the object at the end location. The robot navigation module 334 may determine a necessary orientation at the end location based on information captured by the robot sensor module 331, information stored by the environment map database 240, or based on instructions received from an operator device. In some embodiments, the robot navigation module 334 uses the end location and the determined orientation at the end location to determine the end pose for the robot.

The load handling mechanism 335 is configured to lift and carry loads. In some embodiments, the load handling mechanism includes a fork and a lift assembly configured to raise and lower the fork. In some embodiments, the load handling mechanism 335 is also capable of horizontal movements (e.g., forward, retract, or shift horizontally) and angular movements (e.g., tilt forward or backward).

The controller 336 is configured to control the load handling mechanism 335 of the autonomous mobile robot 140. For example, when picking up a load, the controller 336 lowers the load handling mechanism 335 and adjusts a tilt of the load handling mechanism 335 to align the load handling mechanism 335 with a load. For example, when the load handling mechanism 335 includes a fork, the controller 336 can then moves the fork horizontally cause the fork to reach deeper into a pallet before lifting. After picking up the pallet, the controller may also horizontally move the fork by adjusting a distance between the fork and a body of the robot 140 to stabilize the load. The controller 336 may tilt the fork forward or backward to adjust the load's angle. For stability during transport, the fork may tilt slightly backward to prevent the load from sliding off.

For unloading or storage, the controller 336 aligns the load at the appropriate height and angle for placement. During unloading, the fork may be tilted forward to ensure a smooth release of the load at the designated drop-off point.

When navigating uneven or angled surfaces, such as ramps or piecewise flat floors, the controller 336 adjusts the tilt to compensate for environmental angles, ensuring safe and steady handling. When navigating without a load, the controller 336 adjusts the movement based on the pose of the fork and the geometry of the environment to avoid contact with any slopes. When navigating with a load, the controller 336 additionally takes into account the pose and dimensions of the load to prevent both the fork and the load from striking a slope or encountering overhead obstructions, such as the ceiling of a trailer.

In some embodiments, the controller 336 is configured to control the operation of the fork based on various operational parameters, such as its height, tilt, and/or horizontal position. The controller 336 may also be configured with one or more reference constraints, which can include a minimum distance between the fork and the floor, a maximum allowable tilt angle of the fork, a maximum allowable tilt angle of the robot 140's body, and/or a maximum angle difference between two interconnected piecewise flat segments. The controller 336 continuously adjusts the fork's operational parameters to ensure these reference constraints are met. For example, when the autonomous mobile robot 140 transitions from a flat surface to a sloped area, the operational parameters that were sufficient on the flat surface may no longer meet the reference constraints during the transition. In such cases, the controller 336 adjusts the operational parameters to maintain compliance with the reference constraints. In certain situations, if the maximum or minimum operational parameters are still unable to meet the reference constraints, the controller 336 may stop the operation and issue an alert.

The controller 336 includes both hardware and software components working together to manage the operations of the autonomous mobile robot 140. The hardware components may include one or more processors configured to execute instructions and process data received from robot 140's sensors and other components. The software components include various computer vision and machine-learning algorithms and programs, such as path planning, collision avoidance, and load positioning modules. The software also enables the processors to interpret sensor input, adjust the robot's movements, and execute predefined procedures to complete various tasks.

Further, although the descriptions provided herein are primarily about a fork-based load handling system, the same principles are applicable to other load handling mechanisms. Whether using clamps, grippers, or other types of lifting and transporting equipment, the methods of side-shifting, precise positioning, and sensor-based contact detection described can be implemented in a similar manner. These techniques ensure efficient handling of loads regardless of the specific mechanism employed by the autonomous mobile robot.

### Example Automated Trailer Loading and Unloading

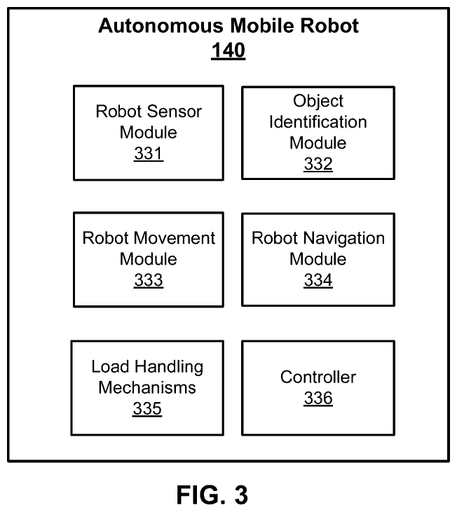

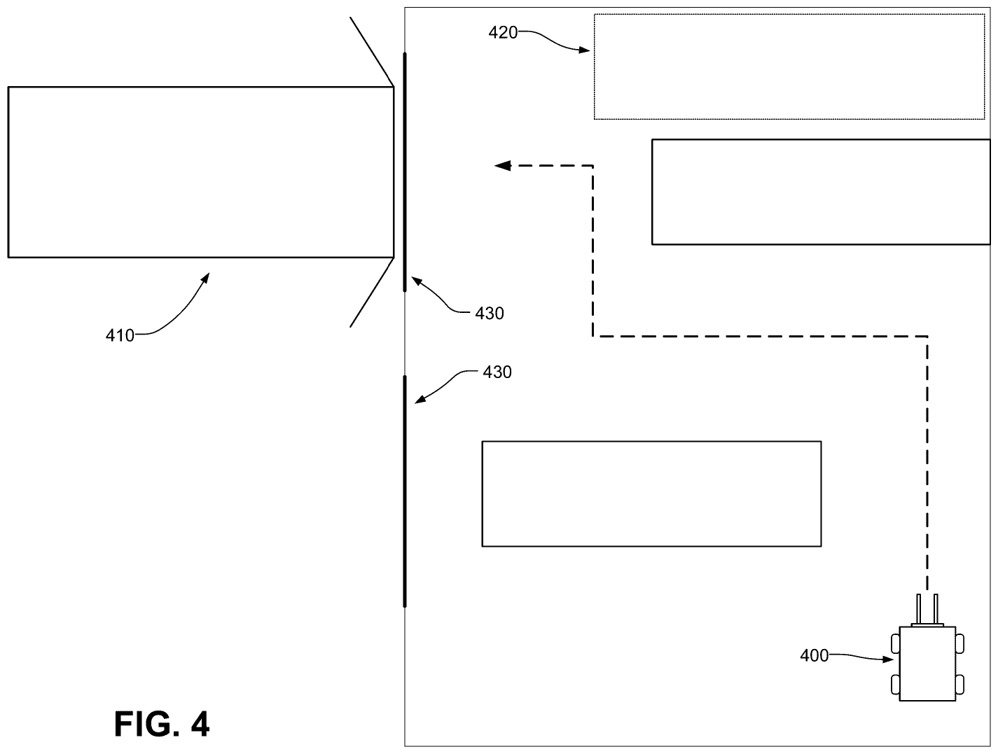

FIG. 4 illustrates an example autonomous mobile robot 400 navigating through a warehouse environment to a trailer 410, in accordance with some embodiments. The autonomous mobile robot 400 may have been instructed by a central communication system to load or unload the trailer 410. The central communication system also may have specified an area 420 to which autonomous mobile robot 400 may unload objects from the trailer 410 or from which the autonomous mobile robot 400 may obtain objects to load into the trailer 410. The central communication system may also specify which of a set docking points 430 the trailer 410 has docked to.

When the autonomous mobile robot reaches the docking point, the autonomous mobile robot may use sensor data to collect information about the trailer. The sensor data is data collected by one or more sensors on the autonomous mobile robot. For example, the sensor data may include LIDAR data captured by a LIDAR sensor and/or image data captured by a camera. In some embodiments, the sensor data includes data that describes the locations of objects and obstacles around the autonomous mobile robot in a two-dimensional space and/or a three-dimensional space. The autonomous mobile robot may determine characteristics of the trailer based on the sensor data. For example, the autonomous mobile robot may determine the width, height, depth, centerline, off-center parking, yaw, roll, and/or pitch of the trailer.

Additionally, the autonomous mobile robot may determine its location relative to the trailer based on the sensor data. For example, the autonomous mobile robot may identify some point or part of the trailer and determine its location with respect to that point or part. The autonomous mobile robot may use the sensor data determine its location and orientation relative the trailer. Furthermore, the autonomous mobile robot may identify objects in the trailer and may determine poses of the objects. For example, the autonomous mobile robot may identify pallets, including the types of the pallets, and may determine their location and orientation within the trailer. In some embodiments, the autonomous mobile robot continually determines its location, and the locations of objects and obstacles, based on continually received sensor data. The autonomous mobile robot may continually receive sensor data on a regular or irregular basis.

In some embodiments, the autonomous mobile robot uses a machine-learning model (e.g., a neural network) to determine characteristics of the trailer based on sensor data. For example, the machine-learning model may be a computer-vision model that has been trained to determine characteristics of a trailer based on image data captured by a camera on the autonomous mobile robot. Similarly, the machine-learning model may be trained to determine the location and orientation of objects within the trailer based on sensor data.

The autonomous mobile robot may enter the trailer and use sensor data of the trailer to determine the autonomous mobile robot's location with respect to the trailer. Additionally, the autonomous mobile robot may determine the location of the objects in the trailer, and any obstacles in the trailer, with respect to the trailer based on the sensor data. The autonomous mobile robot identifies an object to unload from the trailer and manipulates the object using a forklift component. In some embodiments, while the autonomous mobile robot navigates within the trailer, the autonomous mobile robot travels slightly offset from a centerline of the trailer so that the autonomous mobile robot is more likely to be in a correct position to manipulate an object within the trailer. In these embodiments, by remaining slightly offset from the centerline of the trailer, the autonomous mobile robot will likely be able to position its forks to lift an object by simply side-shifting its forks.

In some embodiments, the autonomous mobile robot uses an enhanced navigation algorithm while navigating within the trailer. An enhanced navigation algorithm may enable the autonomous mobile robot to determine its location more accurately within the trailer and to determine more accurately the locations of objects and obstacles within the trailer. The enhanced navigation algorithm may be more precise than a navigation algorithm used by the autonomous mobile robot while the autonomous mobile robot navigates within the warehouse environment. In some embodiments, the enhanced navigation algorithm uses a map within the trailer that has a finer resolution than the environment map. Similarly, the enhanced navigation algorithm may use denser motion primitives to navigate within the trailer than a navigation algorithm used by the autonomous mobile robot when navigating within the warehouse environment. In some embodiments, the enhanced navigation algorithm uses a modified version of A* search to navigate within the trailer. Furthermore, the enhanced navigation algorithm may use sensor data with a narrower field of view than the sensor data used a navigation algorithm used while the autonomous mobile robot navigates within the warehouse environment.

The autonomous mobile robot may detect when it has entered the trailer and may start using an enhanced navigation algorithm upon determining that it has entered the trailer. The autonomous mobile robot may use the enhanced navigation algorithm to position itself to manipulate objects within the trailer and to transport an object out of the trailer. Furthermore, the autonomous mobile robot may detect when it has exited the trailer and stop using an enhanced navigation algorithm upon determining that it is no longer in the trailer.

In some embodiments, the autonomous mobile robot uses a first navigation algorithm to determine a route from a first pose in the warehouse environment to a second pose near an entrance to the trailer. The autonomous mobile robot may then use a second navigation algorithm to determine a route from the second pose to a third pose within the trailer from which the autonomous mobile robot can manipulate an object. The first navigation algorithm may be a navigation algorithm that the autonomous mobile robot uses to navigate within the warehouse environment and the second navigation algorithm may be an enhanced navigation algorithm that the autonomous mobile robot uses to determine its location within the trailer. Thus, the second navigation algorithm may be a navigation algorithm with a higher level of precision than the first navigation algorithm. For example, the second navigation algorithm may use a map with a finer resolution or may use more precise or dense motion primitives to determine a route.

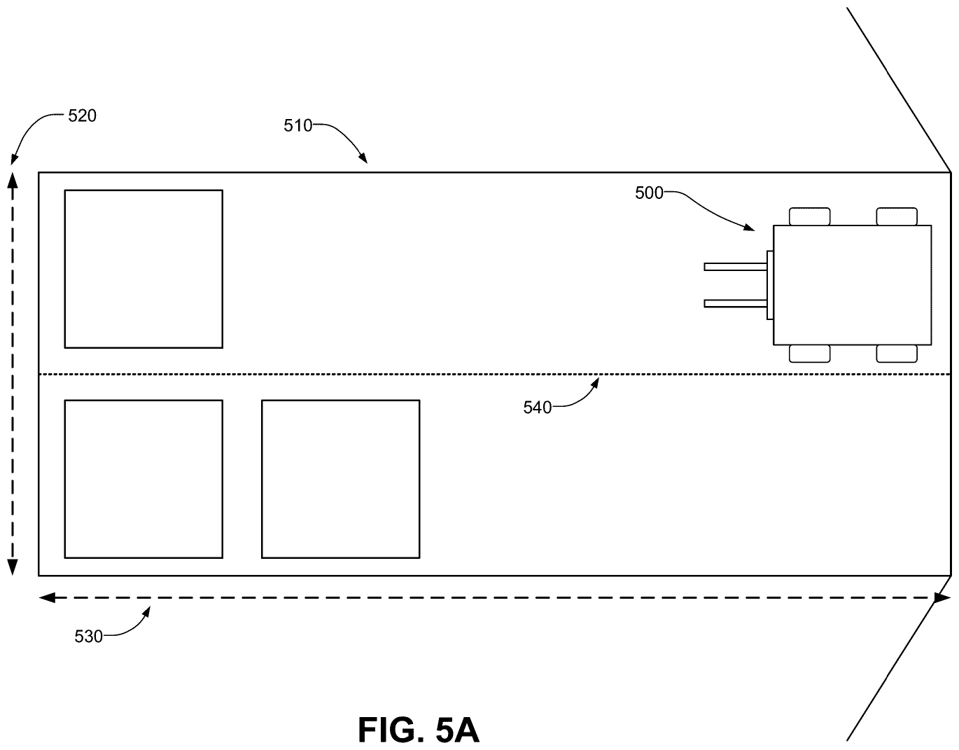

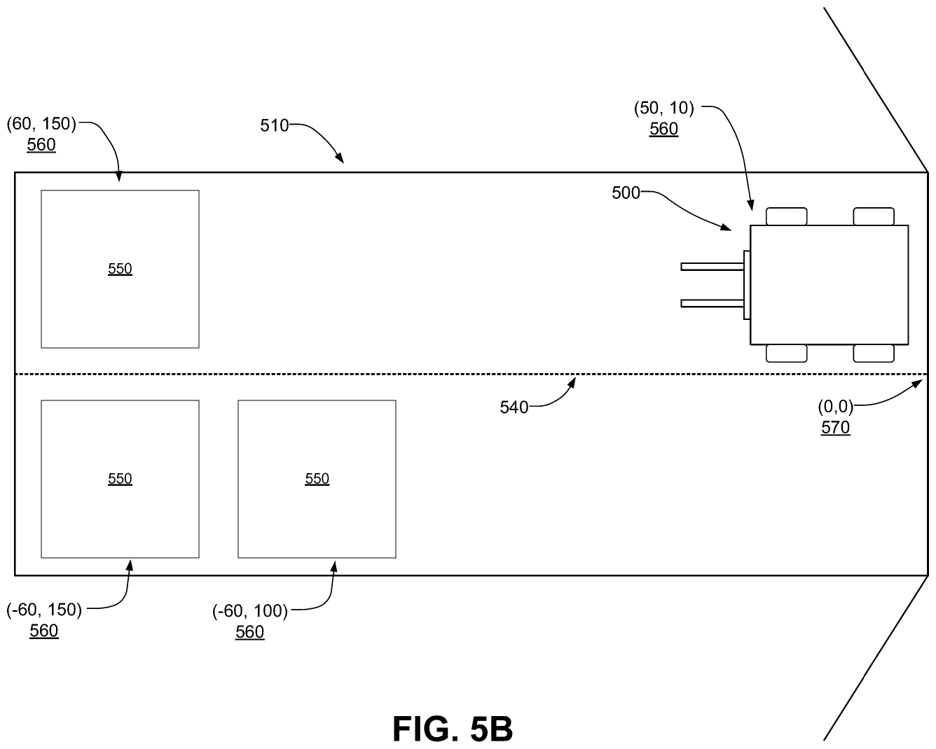

FIGS. 5A and 5B illustrate an example autonomous mobile robot 500 navigating within a trailer 510 and determining characteristics of the trailer 510, in accordance with some embodiments. FIG. 5A illustrates example characteristics that the autonomous mobile robot 500 may determine based on sensor data. For example, the autonomous mobile robot 500 may determine a width 520 and a depth 530 of the trailer 510. Additionally, the autonomous mobile robot 20 may determine the location of a centerline 540 of the trailer 510.

FIG. 5B illustrates example locations 560 of the autonomous mobile robot 500 and objects 550 within the trailer 510, as determined by the autonomous mobile robot 500. The autonomous mobile robot 500 determines the locations 560 of itself and objects 550 relative to the trailer 510. In the embodiment illustrated in FIG. 5B, the locations 560 of the autonomous mobile robot 500 and the objects 550 are determined relative to an origin location 570, however alternative embodiments may determine locations 560 within the trailer 510 relative to any part of the trailer 510.

The autonomous mobile robot generally must unload the last row of the trailer first. In some embodiments, the autonomous mobile robot determines whether the trailer is full and, responsive to determining that the trailer is full, determines that it must unload the last row of the trailer. As used herein, the last row of the trailer is the row that is closest to the doors through which the autonomous mobile robot enters to load or unload the trailer. When the autonomous mobile robot prepares to unload the last row of the trailer, the autonomous mobile robot generally must manipulate the objects in the last row from a ramp that connects the warehouse to the trailer. Therefore, the autonomous mobile robot accounts for the angle of the ramp while approaching the objects.

The autonomous mobile robot uses sensor data to monitor its location relative to the object. Additionally, the autonomous mobile robot may use accelerometer or gyroscopic data to determine its orientation on the ramp and to thereby adjust the orientation of a forklift component coupled to the autonomous mobile robot. The autonomous mobile robot adjusts its forklift components to ensure that the forks are level with respect to the floor of the trailer, rather than the ramp. The autonomous mobile robot thereby ensures that the forks are in the correct orientation to manipulate a pallet. The robot may continually adjust its forks as it approaches the object. For example, the autonomous mobile robot may continually gather new sensor data about its surroundings to continually determine its location and pose with respect to an object in the last row of the trailer and continually adjust its forklift component.

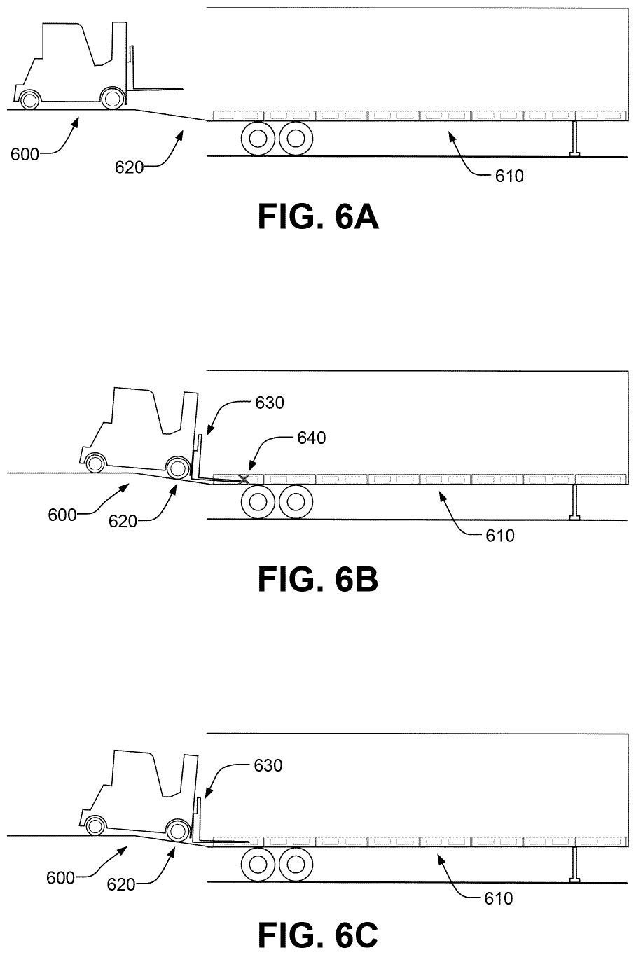

FIGS. 6A-6C illustrate an example autonomous mobile robot 600 unloading objects in the last row of a trailer 610, in accordance with some embodiments. FIG. 6A illustrates an autonomous mobile robot 600 approaching a ramp 620 that leads from the warehouse to the trailer 610. FIG. 6B illustrates an autonomous mobile robot 600 attempting to unload an object in the last row of the trailer 610 without adjusting its forklift 630. The forklift 630 remains level with respect to the ramp 620, meaning that the forks of the forklift 630 would collide 640 with the floor of the trailer 610. FIG. 6C illustrates an autonomous mobile robot 600 that adjusts its forklift 630 to be level with the floor of the trailer 610. By continually adjusting its forklift 630 as it travels down the ramp 620, the autonomous mobile robot 600 ensures that its forklift 630 is able to manipulate an object in the last row of the trailer 610 without having to maneuver itself significantly.

While performing an unload mission, the autonomous mobile robot continues to unload objects from a trailer to a destination area within the warehouse until the trailer is empty. In some embodiments, the autonomous mobile robot determines that the trailer is empty by navigating to the trailer, collecting sensor data of the interior of the trailer, and determining that there are no more objects in the trailer.

In some embodiments, the autonomous mobile robot continues to determine its location with respect to environment map of the warehouse while also determining its location with respect to the trailer. The autonomous mobile robot may use its location with respect to the trailer for navigating within the trailer. However, by continuing to track its location with respect to the environment map, the autonomous mobile robot can more quickly return to navigating with respect to the environment map.

To continue to determine its location with respect to the environment map while navigating within the trailer, the autonomous mobile robot may determine the location of the trailer with respect to the warehouse. For example, the autonomous mobile robot may capture images of the entrance of the trailer and/or of the entire exterior of the trailer. The autonomous mobile robot may then determine the location of the trailer with respect to the warehouse based on these captured images. The autonomous mobile robot may then continue to determine its location with respect to the environment map based on the determined location of the trailer with respect to the warehouse. The autonomous mobile robot performs a mission to load a trailer in a similar manner to how the autonomous mobile robot unloads a trailer. In some embodiments, the autonomous mobile robot performs an “empty run” of the trailer, where the autonomous mobile robot travels into a trailer that is to be loaded to collect sensor data and determine characteristics of the trailer. The autonomous mobile robot may perform this “empty run” without carrying any objects from a source area.

To load the trailer, the autonomous mobile robot identifies an object in a source area to load onto the trailer. The autonomous mobile robot picks up the object and navigates from the source area to the trailer. The autonomous mobile robot determines whether the object needs to be loaded in the last row of the trailer. If the object does not need to be placed in the last row of the trailer, the autonomous mobile robot enters the trailer and identifies a location in the trailer where the object will be placed. In some embodiments, the autonomous mobile robot travels within the trailer slightly offset from a centerline of the trailer so that the autonomous mobile robot is more likely to be in a correct pose to deliver the object to a proper location within the trailer.

If the object needs to be placed in the last row of the trailer, the autonomous mobile robot will continually collect sensor data to determine a correct orientation of its forklift such that the object is delivered level with the floor of the trailer. The autonomous mobile robot continually adjusts the orientation of its forklift until the autonomous mobile robot delivers the object to a proper spot in the last row of the trailer.

The autonomous mobile robot may include components that enable the autonomous mobile robot to navigate within the trailer. For example, the autonomous mobile robot may include a movement system that enables the autonomous mobile robot to rotate in place. Similarly, the autonomous mobile robot may be configured to move to perpendicularly to the direction it is facing without changing its orientation. Thus, the autonomous mobile robot is capable of navigating within often narrow spaces within a trailer and to position itself to be able to manipulate objects within the trailer.

Furthermore, the autonomous mobile robot may include components that enable the autonomous mobile robot to manipulate objects within the trailer. For example, the autonomous mobile robot may include a forklift with the ability to side-shift. Thus, the autonomous mobile robot can position the forklift to manipulate objects without having to reposition itself. The autonomous mobile robot may also include an arm that can lift objects while the autonomous mobile robot maintains a fixed pose. Thus, the autonomous mobile robot can effectively manipulate objects within the trailer from the often limited poses available within the trailer.

### Example Centerline Heuristic-Based Path Finding

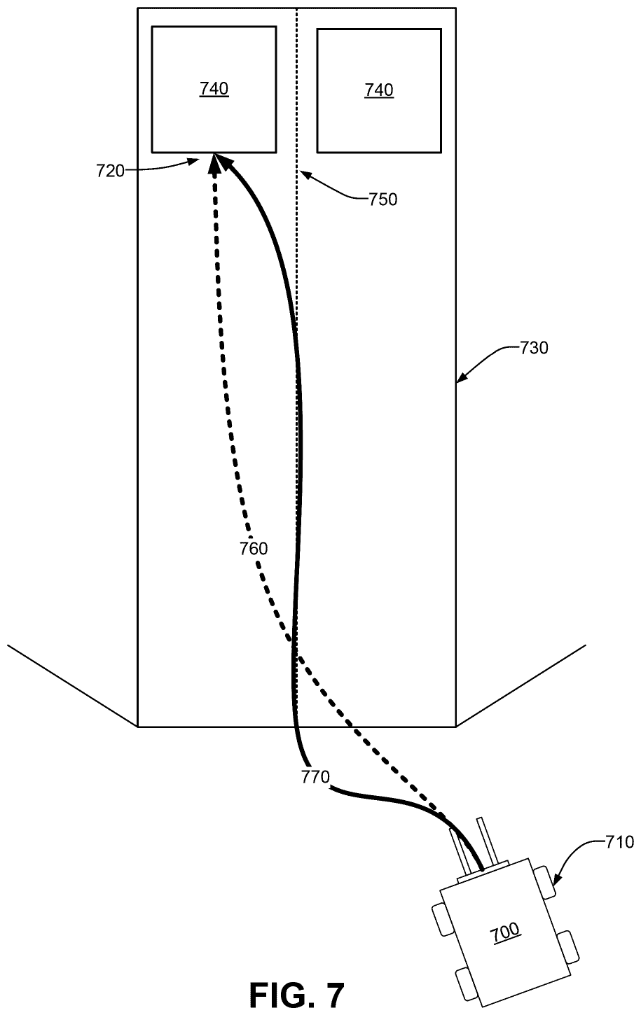

FIG. 7 illustrates an example autonomous mobile robot that uses a centerline heuristic to navigate within a trailer, in accordance with some embodiments. While the FIG. 7 illustrates an autonomous mobile robot entering a trailer, a similar process may be used for an autonomous mobile robot exiting the trailer, as well.

The autonomous mobile robot 700 receives sensor data describing the environment around the robot. The autonomous mobile robot 700 may receive the sensor data from sensors coupled to the robot (e.g., the robot sensor module 331) or from sensors remote from the autonomous mobile robot.

The autonomous mobile robot 700 determines an initial pose 710 of the autonomous mobile robot 700 and an end pose 720 for the autonomous mobile robot 700 based on the received sensor data. The initial pose 710 of the autonomous mobile robot 700 may be a current pose of the autonomous mobile robot, or a pose near the entrance of a trailer 730. The end pose 720 may be a pose for handling an object 740 (e.g., an item on a pallet) within the trailer 730. In some embodiments, the autonomous mobile robot 700 determines the end pose based on instructions from a central communications system.

The autonomous mobile robot 700 computes a centerline 750 of the trailer 730 based on the received sensor data. The centerline is a centerline of the trailer (i.e., is a line that is equidistant from the sides of the trailer). In some embodiments, the autonomous mobile robot 700 generates a map of the interior of the trailer based on the sensor data and computes the centerline based on the generated map.

FIG. 7 illustrates an example path 760 from the initial pose 710 to the end pose 720 that is computed without a centerline heuristic. The autonomous mobile robot may compute the path 760 using a pathfinding algorithm, such as Hybrid A* or State Lattice Planner. A pathfinding algorithm may use heuristics to compute a path from a first pose to a second pose. For example, a pathfinding algorithm may use a heuristic to represent a cost of a set of nodes through which the autonomous mobile robot 700 may pass as part of the path. These nodes may be coordinates or locations within the trailer through which the robot may pass as part of a computed path. The heuristic may have a higher cost for a “worse” node than for a “better” node. For example, a common heuristic is the distance from a node to the end pose, and the heuristic may thereby compute a higher cost (i.e., distance) for a node that is further away from the end pose than a node that is closer to the end pose. The pathfinding algorithms compute a path through nodes that minimize the total cost of the nodes that the path passes through.

As illustrated in FIG. 7, a path 760 that uses traditional heuristics is likely to take a more direct path to the end pose 720. While this may mean that the autonomous mobile robot 700 takes a shorter path, the path 760 may take the autonomous mobile robot 700 closer to the sides of the trailer 730, especially if the end pose 720 is closer to one side of the trailer 730 than the other. This may reduce the space that the autonomous mobile robot 700 has to maneuver if the autonomous mobile robot 700 has to change course within the trailer 730.

FIG. 7 illustrates a path 770 computed using a centerline heuristic. A centerline heuristic is a heuristic that represents a distance of nodes to the centerline 750. For example, the centerline heuristic may increase the cost of a node that is further from the centerline 750 relative to a node that is closer to the centerline 750. In some embodiments, the centerline heuristic assigns a cost value to a node that is proportional to the distance of the node to the centerline of the trailer. Alternatively, the centerline heuristic may assign a constant cost value to nodes within some threshold distance of the centerline, and may assign cost values to other nodes that is proportion to their distance from the centerline minus the threshold distance. In other words, the centerline heuristic may assign cost values to nodes such that nodes within some area (e.g., a rectangular area) around the centerline are constant, and that nodes outside the area are assigned cost values that are proportional to their distance from the area.

The autonomous mobile robot 700 may use a combination of multiple heuristics to compute the path 770 to the end pose 720. For example, the autonomous mobile robot 700 may compute a combination of the centerline heuristic, a heuristic representing a distance of a node to the end pose 720, and a heuristic representing a distance of a node to an obstacle. Thus, the autonomous mobile robot 700 may compute a combined cost for each node that is a function (e.g., a linear combination) of multiple heuristics.

As explained above, the autonomous mobile robot 700 computes the path 770 from the initial pose 710 to the end pose 720 based on the centerline heuristic. The autonomous mobile robot 700 travels along the path 770 to the end pose 720. The autonomous mobile robot 700 may manipulate an object 740 at the end pose 720, such as lifting the object to transport. The autonomous mobile robot 700 may perform a similar process to compute a path to exit the trailer 730.

### Loading from Loading Area to Trailer

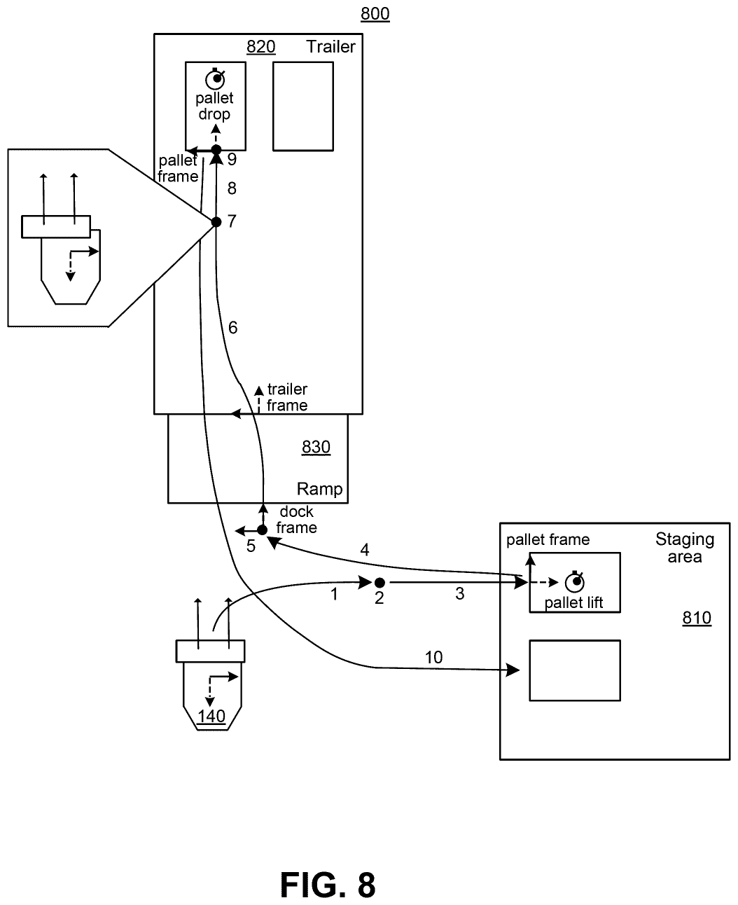

As described above, an autonomous mobile robot 140 may perform a loading mission, where it loads a pallet stacked with an object (referred to simply as a pallet) from a staging area onto a trailer. FIG. 8 illustrates an example environment 800 in which an autonomous mobile robot 140 loads pallets from a staging area onto a trailer, in accordance with some embodiments. As illustrated, the environment 800 includes an autonomous mobile robot 140, a staging area 810, a ramp 830, and a trailer 820. Multiple pallets are staged in the staging area 810. The robot 140 is tasked to load the pallets from the staging area 810 into the trailer 820.

The robot 140 receives input regarding a layout of the staging area 810, trailer load pattern, and ramp pose. In some embodiments, the input is received from an operator device 110, e.g., a smart phone, tablet, or computer. The operator device 110 can be used by a human operator to input the layout of the staging area 810, trailer load pattern, and ramp pose. The human operator may define various parameters before the robot 140 begins its mission. Alternatively, in some embodiments, the robot 140 can gather input about the layout of the staging area, the trailer load pattern, and the ramp pose using its onboard sensors (such as cameras, LIDAR, or other scanning technologies). The robot 140 can detect and model the environment, including the positions of pallets, the orientation of the trailer and ramp, and any other relevant spatial data. This data allows the robot 140 to autonomously refine or confirm the input information during its operations. In some embodiments, the input can also be a combination of both sources. The human operator may initially input a rough layout, trailer load pattern, and ramp pose, and the robot can further refine or update this input by using its sensors as it navigates through the environment.

Responsive to receiving the input, the robot 140 plans a path to a location near a target pallet in the staging area, and executes the path (represented by arrow 1). In some embodiments, the robot 140 determines its current pose (start pose) using its onboard location sensors (e.g., GPS, LIDAR-based localization, or map reference). The robot 140 identifies a goal pose, which is a location near the target pallet that is optimal for picking up the pallet. This goal pose may take into account the pallet's orientation, the space needed for proper positioning, and any constraints from the environment (e.g., obstacles, walls, or other pallets). In some embodiments, the robot 140 uses a path planning algorithm to determine an efficient route from its current pose to the goal pose near the target pallet. Such algorithms for pathfinding may include (but are not limited to) A* (A-Star) or Hybrid A*, Dijkstra's algorithm, rapidly-exploring random trees (RRT), among others. In some embodiments, as part of the path planning, the robot 140's navigation module 334 also considers the locations of obstacles in the staging area. The robot 140 continuously receives updated sensor data to ensure that the path avoids these obstacles. The robot 140 may also compute alternative paths or replan if new obstacles appear or conditions change during navigation.

Once the path is planned, the robot 140's navigation module 334 breaks down the planned route into a sequence of smaller, executable steps, called motion primitives (e.g., move forward, turn, side-shift). The robot 140's movement module then executes these steps to traverse the environment. The movement may include forward movement, turns, and adjustments to avoid dynamic obstacles detected during navigation.

The robot 140 then estimates the pose of the target pallet and confirms whether the orientation aligns with the expected load pattern (represented by arrow 2). Again, the robot 140 can use its onboard sensors, such as cameras, LIDAR, depth sensors, or 3D vision systems, to capture data about the target pallet and its surroundings. These sensors allow the robot to gather information about the position, size, and shape of objects in the environment, including the pallet. In some embodiments, the robot 140's object identification module 332 processes the sensor data to recognize the target pallet among other objects in the staging area. The robot 140 uses pre-programmed or machine learning-based recognition algorithms to identify the target pallet based on known characteristics, such as its dimensions, structure, or any attached visual markers (e.g., barcodes, AR codes, or RFID tags).

Once the target pallet is detected, the robot estimates the pose of the target pallet, which may include (but is not limited to) position and orientation of the target pallet. The position may include x, y, and z coordinates of the pallet in the robot 140's reference frame (i.e., the pallet's location relative to the robot 140). The orientation of the target pallet may include an angle or rotation of the pallet along various axes (e.g., tilt, yaw, pitch). The robot 140 may use sensor data to measure the position of the pallet's corners or edges and determines the pallet's orientation based on the alignment of these detected points.

In some embodiments, the robot 140 may compare the estimated pose of the pallet with the expected load pattern provided by predefined mission parameters. The expected load pattern may include the orientation in which the target pallet should be positioned (e.g., parallel or perpendicular to certain reference points like a warehouse wall), a height or tilt of the pallet, the intended position of the pallet in the overall load configuration (e.g., is it the first pallet in the row, or should it be aligned with other pallets?). In some embodiments, the robot 140 may also check if the detected pallet's orientation matches the expected load pattern. This may include verifying whether the pallet is rotated or tilted according to the expected angle, whether the pallet is positioned correctly within the expected spatial boundaries (e.g., within a predefined zone or along a specific axis in relation to other pallets). If the pallet's orientation is within acceptable tolerance levels of the expected load pattern, the robot confirms its alignment. In some embodiments, if the robot 140 detects a misalignment (e.g., the pallet is rotated incorrectly, tilted or in wrong position), the robot may attempt to autonomously adjust its approach to realign with the pallet. If the pallet is severely misaligned, the robot 140 may generate an alert or request human intervention to manually adjust the pallet.

Once the pallet pose is confirmed, the robot 140 approaches and lifts the pallet (represented by arrow 3). Upon reaching the location near the target pallet, the robot 140 may adjust its final position to align correctly for picking up the pallet. This alignment may involve fine-tuned movements such as small forward, backward, or side shifts to ensure proper fork positioning. The robot 140 positions itself directly in front of the pallet, aligning its fork with the pallet's entry points (e.g., fork pockets). If the robot 140 is not perfectly aligned with the pallet after the initial approach, it may use its side-shift capability to laterally adjust the position of the forks. Once the robot is correctly aligned, the controller 336 of the robot lowers the forks to the correct height for entering the pallet. The height of the fork may be determined based on sensor data or preprogrammed parameters. The robot 140 then moves forward, sliding the forks into the pallet pockets. As the forks slide in, the robot 140 can make small positional adjustment, such as slight forward, backward, or side movements, which may be guided by continuous sensor feedback. After the forks are fully inserted into the pallet, the robot 140's fork raises the fork, lifting the pallet off the ground to a predefined height based on the load's requirement and the environment's constraints. In some embodiments, the robot 140 may also adjust the angle of the fork to ensure the pallet remains stable.

After picking up the pallet, the robot plans and executes a path toward a next goal pose—the trailer entrance (represented by arrow 4). Similar to the planning and executing the path toward the target pallet, the robot 140 determines a next goal pose—the position near or at the trailer entrance. The goal pose can be based on predefined instructions or dynamically determined based on real-time environment and trailer pose detected by the robot 140's sensors. Again, the robot breaks the planned path into smaller executable steps (motion primitives), including moving forward a certain distance, turning at specific points, adjusting its position laterally (side-shifting) if necessary to avoid obstacles. The robot may also control its speed based on environmental conditions. It may slow down in tight spaces or near potential obstacles or slopes, and accelerate in open areas.

As the robot 140 reaches the trailer entrance (represented by a point 5), the robot 140 stops and executes a trailer detection algorithm to estimate the trailer's pose. Similar to the estimation of the target pallet pose, the robot 140's onboard sensors, such as LIDAR, camera, depth sensors, and possibly ultrasonic sensors, may be activated to collect information about the environment. 3D vision systems or stereo cameras may also be used to capture a three-dimensional model of the trailer. In some embodiments, the robot 140 may identifies the trailer based on its known dimensions, shape, and location in the environment. After detecting the trailer, the robot 140 estimates the trailer's pose, including the position and orientation of the trailer.

The robot 140 then plans and executes a path (represented by arrow line 6) to the next goal pose (represented by point 7) in the trailer. This path and goal pose are aimed to ensure that the robot 140 completes the mission by following a straight path for the final predefined time or distance. Similar to planning and executing the path towards the target pallet and trailer entrance, the robot 140 determines the next goal pose and navigates to it.

After the robot reaches this goal pose (point 7), the robot side-shifts its fork. In some embodiments, the robot side-shifts the fork until it detects a contact between a lateral side of the pallet and a wall of the trailer. The detection of the contact may be based on one or more onboard sensors. In some embodiments, force sensors or load cells are embedded in the fork or lift mechanism of the robot 140. These sensors can measure forces exerted on the fork or pallet as the fork moves or side-shifts. When the lateral side of the pallet makes contact with the trailer wall, an increase in lateral force or resistance is detected by these sensors. The robot uses this sensor data to determine if there has been contact with the wall.

In some embodiments, the robot 140 may be equipped with proximity sensors (such as ultrasonic or infrared sensors) mounted on the sides of the fork. These sensors can monitor the distance between the fork and the surrounding environment, including the walls of the trailers. In some embodiments, LIDAR sensors or 3D cameras may be mounted on the robot to create a three-dimensional map of the trailer environment. These sensors may detect the exact position of the pallet relative to the walls of the trailer. In some embodiments, the robot 140 can detect shifts or vibrations in the pallet as it is moved, using feedback from sensors monitoring stability of the load. If the lateral side of the pallet makes contact with the trailer wall, the robot may detect subtle shifts in the pallet's position or balance. In some embodiments, the robot's motor, which control the fork and side-shifting mechanism, is monitored for current spikes. A sudden increase in motor current could indicate that the fork is encountering resistance, which could occur if the lateral side of the pallet contacts the trailer wall. The robot 140 can use these spies in current as an indirect indicator of contact.

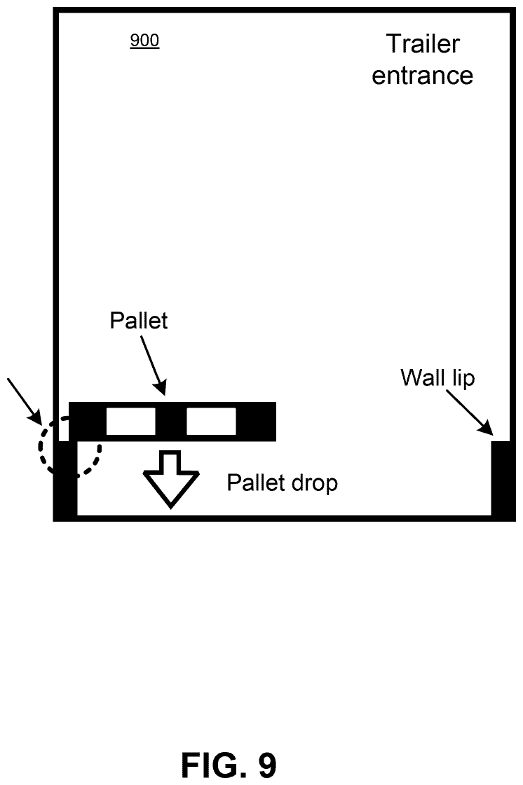

In some embodiments, the trailer may include wall lips along a bottom of is interior wall. In the context of pallet handling, the wall lips pose a potential obstacle that the robot 140 must account for during pallet placement. FIG. 9 illustrates a cross-sectional view of a trailer where the trailer includes wall lips along the bottom of two side walls. These lips may be a structural element designed to reinforce the trailer. As shown in FIG. 9, the pallet is positioned near the side wall of the trailer, above the lip of the trailer wall, after the fork side-shifts toward the side wall until contact is detected between the pallet and the trailer's side wall. If the robot 140 drops the pallet from this position, the pallet could catch or get stuck on the lip, which could damage the load or interfere with the drop-off process.

To solve the above described challenge, after the robot detects a contact between the wall and the pallet, the robot 140 then side-shift the fork back away from the trailer wall by a predetermined small distance corresponding to a width of the wall lip, e.g., 1 centimeter, 2 centimeters, or a few centimeters. Alternatively, the robot 140 determines a distance based on computer vision or another sensor that can detect the width of the wall lip.

After the side shifts of the fork, the robot 140 moves forward until it reaches the goal pose or detects a front collision (represented by arrow 8). In some embodiments, the robot 140 may perform side-shift and backoff from the side wall by a predetermined distance again. The robot 140 may also perform backoff from the front wall or front row of pallets too. This predetermined distance is a small distance, e.g., 1 centimeter, 2 centimeters, or a few centimeters. The robot then lowers the pallet at the goal pose (represented by point 9) to a reference height and drops the pallet. In some embodiments, the robot 140 adjusts the side-shift before dropping the pallet to make sure, ensuring the pallet won't catch on any trailer wall lips.

After dropping the pallet, the robot 140 plans and executes a path to exit the trailer and navigates to a next pallet pick up pose (represented by arrow 10. In some embodiments, before exiting the trailer, the robot 140 detects the pose of the dropped pallet for use in future planning. The robot 140 then repeats this process for the next pallet in the staging area.

If there are more than two pallets in a row, the second pallet may be handled similarly to the first, with the exception that the second pallet will side-shift to align next to the side surface of the first pallet. In some embodiments, the side-shift stops when the robot 140 detects contact between the sides of the first and second pallets. Alternatively, the side-shift distance can be determined based on the estimated pose of the first pallet.

In some cases, the fork may be longer than the length of the pallet, causing the robot to protrude beyond the end of the pallet. In such situations, the robot 140 takes extra steps to prevent the protruding forks from damaging a pallet in a previous row or the front wall of the trailer. In some embodiments, the robot detects motion of the pallet on the forks. Based on the detected motion, the robot can automatically determine if the motion is large enough to indicate that the forks are sticking out from the pallet in front. To prevent potential damage to the load in the previous row, the robot first drops the pallet, then moves back a small distance—slightly larger than the estimated protrusion of the forks—lifts the pallet again, and finally proceeds with the standard drop sequence.

### Loading Last X Rows

The process described above can be repeated for all pallet rows except for the last X rows. The number X is automatically determined by the robot, starting after the row where both the robot (including all its wheels) and the pallets in that row can be fully positioned inside the trailer, including the forks that are not under the pallet. Notably, when placing the pallets in the last X rows, the robot 140 and the pallet cannot be fully inside the trailer at the same time. When working with these rows, the robot 140 is positioned close to the edge of the trailer, so the side-shift movement needs to be delayed as much as possible. In particular, the side-shift should not be performed while the pallet is still completely outside the trailer, as no contact can be detected at that point. Additionally, it is preferable not to perform the side-shift when the pallet is only partially inside the trailer, as this could cause the pallet to rotate on the forks if a portion of its side comes into contact with the trailer wall. However, in certain cases (e.g., when placing the last pallet in the last row), the side-shift may need to be performed before the entire pallet is fully inside the trailer.

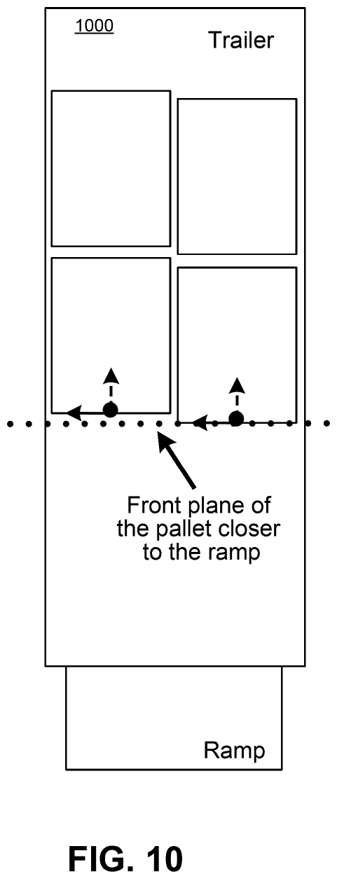

When placing pallets in the last X rows, the robot 140 determines a pose of a previous row of pallets. This includes determines a front plane of the previous row of pallet. FIG. 10 illustrates an example trailer 1000 in which a front plane of a previous row of pallet is determined, in accordance with some embodiments. The pallets in the trailer are not always aligned perfectly. Therefore, the robot 140 determines a front plane of the closest pallet to the ramp to avoid the front collision with that pallet.

Based on the front plane of the pallet closest to the ramp, the robot 140 can determine whether there is enough space in the trailer to place another row of pallets. If the robot 140 determines that sufficient space is available, the robot 140 determines its target pose based on the front plane of the previous row of pallets, where the side-shift should be performed. This target pose ensures that the new pallet is positioned as close as possible to the front plane of the previous row.

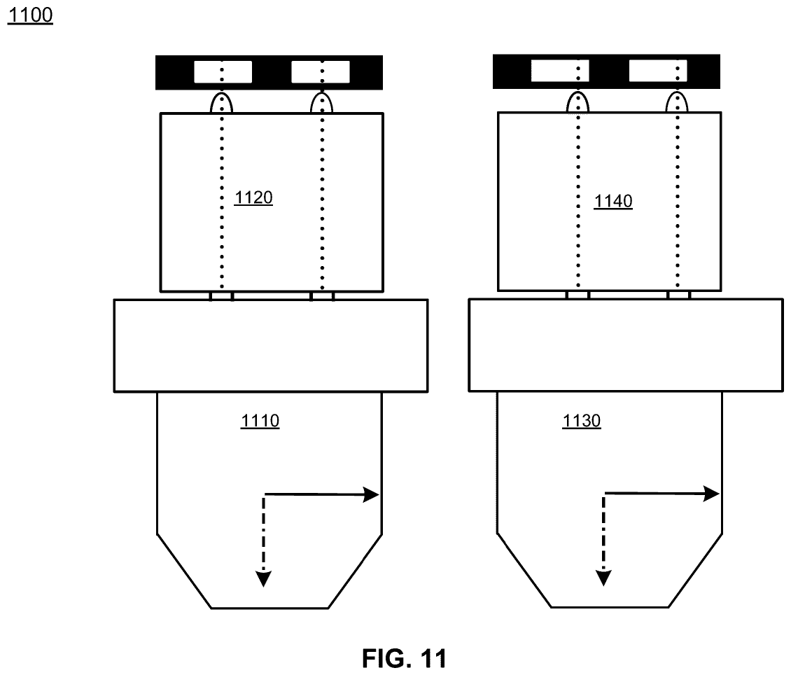

The determined target pose of the robot 140 may result in several different scenarios: (1) the pallet to be placed in the row will be fully inside the trailer when the side-shift is performed, (2) the pallet will be partially but sufficiently inside the trailer when the side-shift is performed, or (3) the pallet will not be sufficiently inside the trailer to use the side-shift to estimate the distance from the wall or another pallet. In the first scenario, the robot 140 can follow predetermined procedures to perform the side-shift. However, in the second and third scenarios, the robot may need to take additional steps to prevent the pallet from rotating and ensure it is properly positioned inside the trailer. Additional details about placing pallets in the last X rows are further described below with respect to FIGS. 10-11.

For the first pallet in a row (which is one of the last X rows), a controller of the robot may use onboard sensors (it can be for example a stereo camera, a TOF camera, or a 3D LIDAR) to perform pallet detection for all of the pallets in the previous row that was loaded. Then based on this information, the controller may determine a distance when it is safe to start side-shifting. From the pallets in the previous row, the controller first determines the pallet that is closest to the ramp, and then uses the position of the front pallet plane, with additional user-defined distance, to determine when to start side-shifting. The lateral offset from the trailer wall is determined based on the previous pallet pose and side-shift limitation.

The robot 140 determines a pose based on the front plane of the closest pallet to the ramp and navigates to that pose. The robot 140 then side shifts the fork until a contact between the pallet and the side wall of the trailer is detected. The robot 140 then side shifts the fork back away from the wall of the trailer by a distance corresponding to a width of the lip, and then moves forward slightly. The distance of forward moving is determined based on the available space, i.e., goal pose and length of the trailer. Alternatively, the forward moving stops when the robot 140 detects a contact between the front plane of the previous row and the current pallet. The robot 140 may also side shift again and back off again to drop the pallet.

If there are more than two pallets in the row, the logic for the middle pallets in the last row is as follows. Based on the poses of the pallets in the previous row, the pallets in the current row, the robot automatically determines the lateral offset from the pallet in the current row, and the exact position when to start the side-shift in the current row, and the exact position when to start the side-shift based on the pallets in the previous row. The procedure for placing the pallet is the same as the first pallet, except that the side-shift contact happens with the pallet that is next to it, instead of the trailer wall.

For the last pallet in the row, the robot first performs pallet pose detection on the pallets placed in the row. Then based on the front plane of the closest pallet in the previous row and a user-defined distance, the robot estimates when the side-shift can start. The rest of the procedure is the same as before. In this case, the forward motion is larger than in the case of the first pallet, as the robot needs to move forward for at least one pallet length to be able to slide it inside without hitting the neighboring pallet.

This process is repeated for all the pallets until the end, except for the last one. For the last pallet, there is no guarantee that the side-shift will happen within the trailer, however, in most cases, the pallet will be at least half the length inside the trailer, and therefore it will not be rotated when side-shifting. If this is not the case, it is also possible to take this into consideration when lifting the pallet from the staging area, during the lifting, before fully lifting the pallet, the robot may side-shift the fork towards one side (the one where we expect the trailer wall to be close to the pallet. For example, if the trailer wall is on the right side, side-shift should be towards the right.

FIG. 11 illustrates examples of different positionings fork at different locations relative to pallet pockets in accordance with one or more embodiments. There are two robots 1110 and 1130. The robot 1110 (on the left) carries a pallet 1120, and the robot 1130 (on the right) carries a pallet 1140. The forks of robot 1110 are inserted at centers of the pockets of the pallet 1120, while the forks of robot 1130 are inserted towards right side of the pockets of the pallet 1140.

To make sure the forks are positioned towards one side of the pallet pockets, the robot may insert its fork into the pockets of the pallet first and slide the pallet over the floor slightly, so that the space between the pockets and the fork is minimized when the fork hits the pallet wall. The sliding of the pallet over the floor is not desired, however, because the robot does not know the exact amount of side-shift motion we need to reach the end of the pallet pockets, it can happen that the robot 140 moves the pallet slightly.

When at least a portion of the pallet is inside the trailer, the robot 140 can perform the side shift to the right, to detect a contact between the pallet and the side wall of the trailer. Because the pallet is placed towards a side of the robot, when the contact happens, even though only a portion of the pallet is in contact with the side wall of the trailer, the palate should not rotate.

If the space for the last pallet is tight, the robot may perform a motion that straightens the pallet and creates some additional space for squeezing in the pallet. The robot may use its onboard sensors to estimate the space between the last dropped pallet obtained by using the semantic pose estimation and the trailer wall that is obtained based on the trailer detection. If there is enough space the vehicle will proceed to the drop, otherwise report an error. Using the on-board sensor, for example, ultrasonic distance sensor or a 1D LIDAR, the robot may detect whether the pallet moves on the forks. This means that there is not enough space to squeeze the pallet in then, responsively, the robot may perform the following set of actions if the pallet is inside at least a threshold length (e.g. quarter of the length inside); if not, the vehicle may report an error and abort. The robot side shift towards the neighboring pallet until it detects the side-shift contact, pushing the neighboring pallet slightly. The robot side-shifts toward the trailer wall until it detects the contact. The robot backs off from the trailer wall for a small distance and proceeds to the drop.

Notably, the method used for placing pallets in the last X rows can also be applied to the previous rows. In some embodiments, the same method is used for placing all pallets in all rows. Alternatively, different methods may be used for placing pallets in the previous rows and the last X rows to reduce computational demand and conserve battery usage.

### Unloading from Trailer to Staging Area

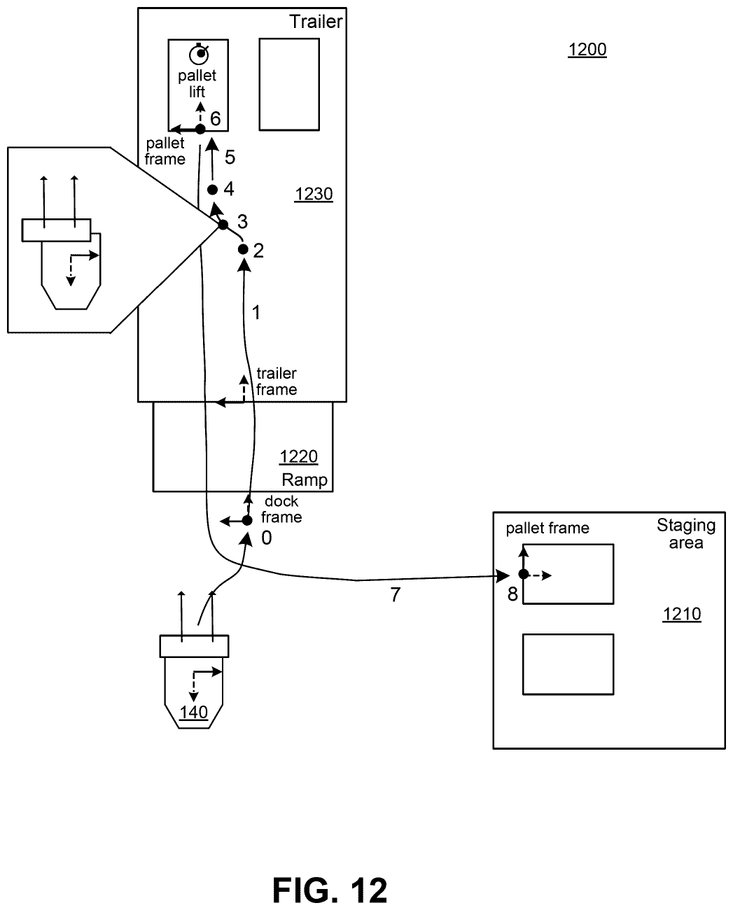

The autonomous mobile robot 140 can also perform unloading from a trailer to a staging area. FIG. 12 illustrates an example environment 1200 in which an autonomous mobile robot 140 unloads pallets from a trailer onto a staging area, in accordance with some embodiments. As illustrated, the environment 1200 includes an autonomous mobile robot 140, a staging area 1210, a ramp 1220, and a trailer 1230.

If it is a first time that the robot is going onto the trailer, the exact trailer pose may not yet be determined. The robot 140 moves to the dock in front of the trailer and uses the trailer detection algorithm for estimating the pose of the trailer (represented by arrow 0). The trailer detection algorithm returns a first pallet that is observable in the trailer, which may be combined with other input data. The input data may include trailer pattern and entered by a user during an initial project setup. The robot 140 uses the detected first obstacle and the input data to obtain the pose of the pallets in a first visible row.

The robot 140 then moves towards the first obstacle along the trailer centerline (represented by arrow 1) When the robot 140 is fully inside the trailer at the centerline, the robot 140 starts trailer detection to continuously to refine the determined trailer pose. If the trailer's pose is already known, the robot 140 directly moves from the staging area to the trailer centerline to prepare for pallet pose estimation.

Further, while at the centerline (represented by point 2), the robot 140 also uses pallet pose estimation to estimate the poses of all the observable pallets. Based on this information, known pallet type, and trailer dimensions from the trailer detection, the robot 140 computes the clearance of each pallet from the walls and each other. Based on the pallet poses, distance from the trailer walls, and distance at the pallet center from the ramp centerline, the robot decides to select a target pallet whose pose is closest to the ramp centerline.

Based on the target pallet pose, the robot determines a goal pose based on a predefined distance in front of the target pallet, determines and executes a path towards that goal pose (represented by arrow 3). In some embodiments, during the execution of the path, the robot starts side-shifting for a predefined distance such that the fork aligns with the pallet pockets when the robot reaches the goal pose. Alternatively, the robot side-shifts after it reaches the goal pose to align the fork with the pallet pockets.

In some embodiments, after the robot reaches the goal pose (represented by point 4), the robot 140 may repeat the pallet pose estimation to obtain a more accurate assessment of the pallet's position. In some embodiments, this step is optional. The robot then moves in a straight line towards the next goal pose for picking up the pallet (represented by arrow 5). In some embodiments, the robot may check if the forks are aligned with the pallet pockets. If they are not, the robot may perform a side-shift to properly align the forks with the pallet pockets.

The robot 140 picks up the pallet (at point 6) and plans and executes a path to the staging area (represented by arrow 7). Similar to the loading steps described with respect to FIG. 8, the robot 140 may first determines a goal pose for dropping the pallet, and determines a path from its current pose to the goal pose based on a path planning algorithm, such as A*, Dijkstra's, or Rapidly-exploring Random Trees. Once the path is determined, the path is broken down into smaller, executable steps called motion primitives, including moving forward, backward, turning, stopping, or side-shifting. Depending on the path, the robot may move in a straight line or follow a curved path. The path takes into account the robot's ability to maneuver in tight spaces or in environment with obstacles. In some embodiments, the path includes a straight line back. While the robot is executing this path, the robot 140 can optionally tilt the load towards itself in order to increase stability. Further, the robot 140 may start side-shifting towards the middle, once it is clear from other pallets, which may be determined based on a front plane of the closest pallet detected in a previous step. When executing the path, the robot 140 may also gathers real-time data from its sensors to track its position relative to the environment, including walls, obstacles, or other statis or moving objects. When the robot 140 reaches the goal pose in the staging area (at point 8), it drops the pallet.

The above described process repeats until the trailer is cleared or the project plan is completed.

### Unloading First X Rows

Similar to the loading process, additional precautions may be applied when the robot is unloading the first X rows. The value of X is determined in the same manner as during loading. The side-shift toward the trailer centerline is performed as soon as the pallet is clear of other pallets in the current or previous row, in order to avoid contact with the dock doors or dock seal during movement, as such contact could damage the load or cause it to rotate on the fork.

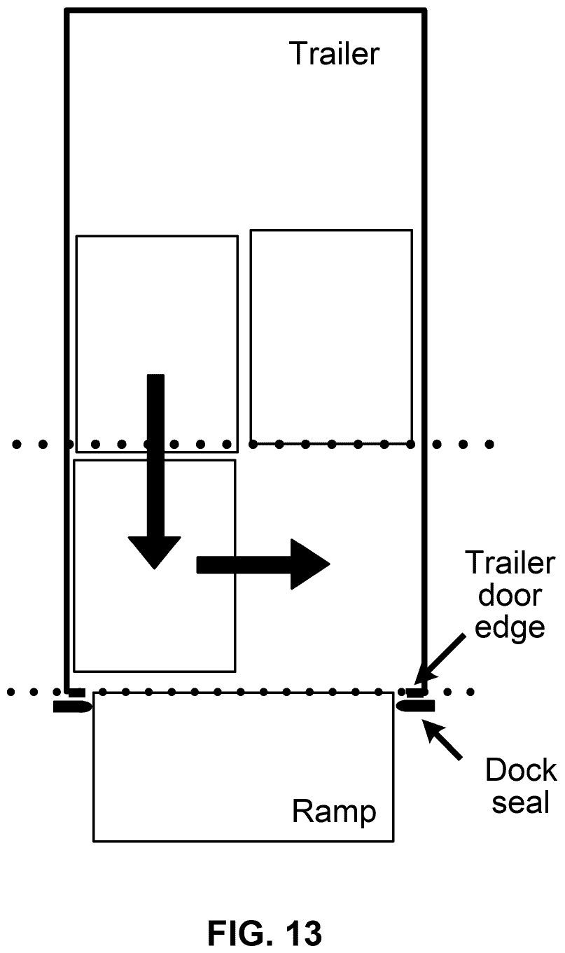

FIG. 13 illustrates an example environment 1300, in which a pallet in one of the first X rows is to be unloaded, in accordance with one or more embodiments. When the robot 140 is unloading a first pallet in the row, the robot 140 performs a clearance detection. The clearance detection refers to a process by which the robot 140 uses its sensors and algorithms to determine an amount of space or clearance available around a pallet, before performing actions like moving or unloading. The robot 140 determines whether there is at least a threshold amount of space between two neighboring pallets. There may or may not be at least the threshold amount of space. When there is at least the threshold amount of space, the robot 140 has more room to work with, and is able to pull a pallet out with fewer steps.

When there is less than the threshold amount of space, the robot 140 may need to take additional steps to accurately position the pallet before pulling it out. In some embodiments, the robot may side-shift the fork (carrying the first pallet) toward the second pallet by the determined distance between the pallets plus a small predetermined amount. In some embodiments, the robot may side-shift until it detects contact between the two pallets. The robot 140 may then side-shift the fork back toward the trailer wall by a small predetermined amount, positioning the pallet as further away as possible from the trailer wall while avoiding contact with the neighboring pallet.

This procedure is typically only necessary for the first pallet in the first row but can also be applied to the first pallet in other rows. In the first row, there may not be enough space to pull out the pallet without hitting the trailer door edge or dock seal without this procedure. Thus, this procedure is performed to maximize the distance between the pallet and the trailer wall. For other rows, there is usually sufficient space to pull out the pallet and side-shift to the center before reaching the trailer door edge or dock seal. Further, if there is at least the threshold amount of space detected between the pallets in the first row, the robot may just pick up a pallet, side-shift and proceed to a next step.

After completing the above procedure, the robot 140 moves the pallet out by a distance determined based on the pose of the second pallet (the adjacent pallet) in the row, plus a small predefined amount, ensuring that the furthest point of the picked pallet clears the front plane of the second pallet. If this motion would move the pallet outside of the trailer, the robot may still attempt to move past the trailer door frame and dock seal, because in the previous procedure the robot 140 has maximized the clearance between the pallet and the trailer wall in the first step. If the robot detects, using its on-board sensors, that the pallet has shifted on the fork, it may abort the mission, as this could indicate that the pallet has hit the trailer wall or dock seal. Once the robot 140 moves the pallet out, it stops and side-shifts its fork back to the center.

For the second pallet in the row, the robot will first perform a pose detection for a pallet that is visible in the next row. If this pallet overlaps the pallet in the current row, based on the pallet poses, the robot will determine how far out it needs to pull the second pallet (the furthest point of the picked pallet needs to be cleared from the nearest point of the other pallet) before the robot can side-shift back to the center. If the pallet in the next row does not overlap the pallet in the current row, the robot will just move out for a predefined small distance and side-shift to the center.

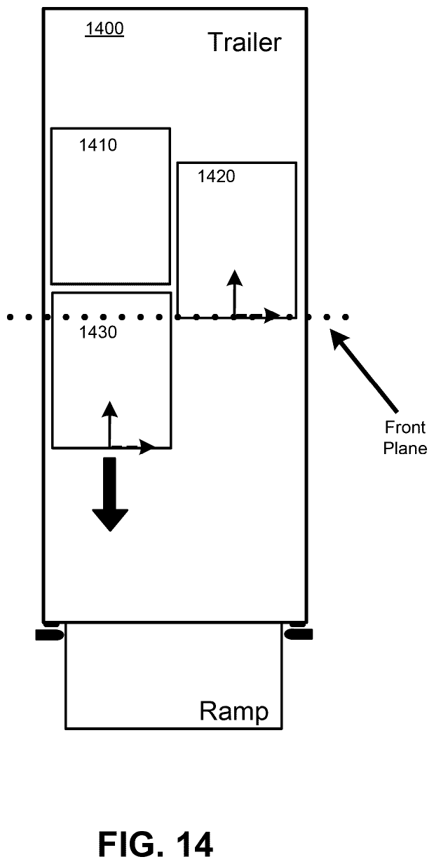

FIG. 14 illustrates an example trailer 1400, in which a target pallet overlaps a pallet in a previous row, in accordance with some embodiments. As illustrated, the trailer 1400 includes three pallets 1410, 1420, 1430. Theses pallets are not necessarily aligned in perfect rows. The target pallet 1430 is to be moved out. However, before a side-shift can be performed on the pallet 1430, the robot 140 needs to pull the pallet further out to be cleared from the front plane of the pallet 1420.

Notably, any of the steps for unloading for the last rows described above can be applied to any other row or pallet too. It is also possible to combine, remove, or add any additional steps for specific pallets. However, having any extra logic impacts performance, and therefore it is generally advantageous to limit additional logic to only the last rows or the last pallet to reduce computational demands and battery utilization.

In addition to forks for handling pallets, autonomous mobile robots 140 may be equipped with a variety of other load handling mechanisms. For example, grippers can be used to grasp and transport irregularly shaped objects, while vacuum lifters are suitable for handling flat, smooth surfaces like glass or sheet metal. Clamps can securely hold large containers or bundles. Each of these load handling mechanisms may operate on similar principles of precise positioning, alignment, and sensor-based feedback to ensure accurate handling in confined or constrained spaces, much like forklifts managing pallets.

### Example Method for Loading Pallets from Staging Area Onto Trailer

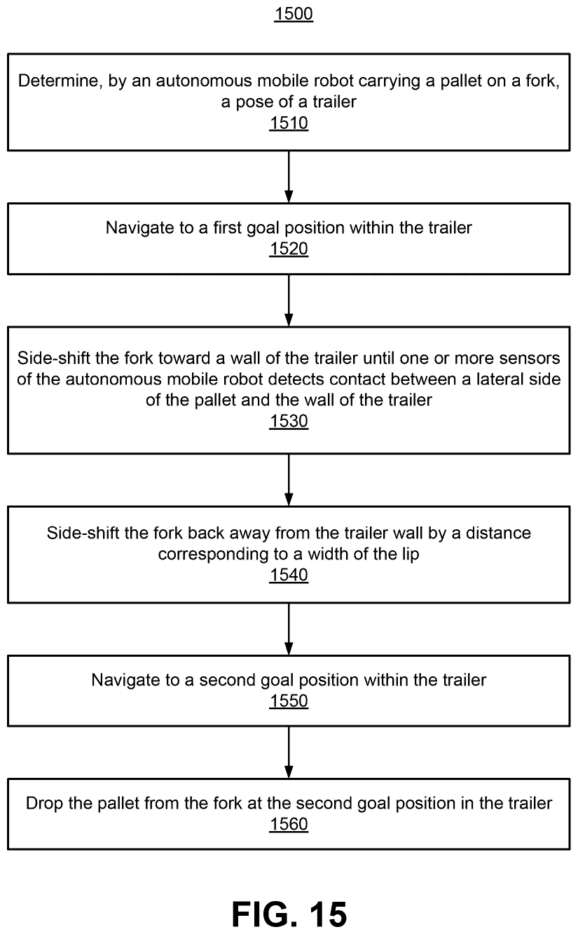

FIG. 15 is a flowchart of an example method 1500 for loading pallets from a staging area into a trailer, in accordance with some embodiments. Alternative embodiments may include more, fewer, or different steps, and the steps may be performed in a different order from that illustrated in FIG. 15. Additionally, while FIG. 15 is primarily described in terms of actions taken by an autonomous mobile robot (e.g., robot 140), the steps may be performed, in part or in whole, by a central communication system in communication with an autonomous mobile robot.

An autonomous mobile robot 140 is tasked to load a pallet from a staging area onto a trailer. The robot 140 picks up a pallet from the staging area and moves to a dock of the trailer. The robot 140 may then moves to a trailer entrance. The robot 140 determines 1510 a pose of a trailer by one or more sensors integrated on the robot 140. The one or more sensors may be a LIDAR, stereo camera, 3D camera, depth sensor, and/or ultrasound sensor,

The robot 140 then navigates 1520 to a first goal position within the trailer. The first goal position is determined based on the pose of the trailer. In some embodiments, the first goal position is aimed to ensure that the robot 140 completes the mission by following a straight path from the first goal position to a final goal position for the final predefined time or distance.

Responsive to reaching the first goal position, the robot 140 side-shifts 1530 the fork toward a wall of the trailer until one or more sensors of the autonomous mobile robot detects contact between a lateral side of the pallet and a side wall of the trailer. The detection of the contact may be based on the one or more sensors. In some embodiments, force sensors or load cells are embedded in the fork or lift mechanism of the robot 140. These sensors can measure forces exerted on the fork or pallet as the fork moves or side-shifts. When the lateral side of the pallet makes contact with the trailer wall, an increase in lateral force or resistance is detected by these sensors. Alternatively, or in addition, the robot's motor, which control the fork and side-shifting mechanism, is monitored for current spikes. A sudden increase in motor current could indicate that the fork is encountering resistance, which could occur if the lateral side of the pallet contacts the trailer wall. The robot 140 can use these spies in current as an indirect indicator of contact.

Referring to FIG. 9, the side wall of the trailer includes a lip along its bottom. When the pallet is in contact with the side wall, the lip is beneath the pallet. Thus, responsive to detecting the contact between the lateral side of the pallet and the side wall of the trailer, the robot 140 side-shifts 1540 the fork back away from the trailer wall by a distance corresponding to a width of the lip.

The robot 140 navigates 1550 to a second goal position within the trailer, which is within a predetermined threshold distance from the drop position. The second goal position is also determined based on the pose of the trailer. At this second goal position, the robot 140 drops 1560 the pallet from the fork. In some embodiments, the robot moves in a straight line from the first goal position to the second goal position. In other embodiments, the robot moves straight until detecting contact between the front side of the first pallet and the front wall of the trailer. Upon detecting this contact, the robot backs off by a predetermined distance to prevent the front side of the pallet from scraping against the front wall during the pallet drop.

In some embodiments, the robot 140 determines whether the fork extends beyond a side of pallet by a distance, i.e., the fork sticks out of the pallet. This could happen when the length of the load on the pallet is smaller than the length of the fork. The robot can determine the distance based on detected motion of the pallet on the fork. Responsive to determining the distance that the fork sticks out, the robot 140 drops off the pallet at the first goal position, moves back for a predetermined distance that is greater than the determined distance, and lifts the pallet again before navigating to the second goal position, such that the fork is no longer stick out.

If each row of pallet in the trailer includes only one pallet, a second pallet may be loaded similarly as the first pallet, except that the front surface of the second pallet will be against a rear surface of the first pallet.

If each row of pallet in the trailer includes only two pallet, the second pallet may be loaded similarly as the first pallet, where a lateral side surface of the second pallet is against an opposing side wall of the trailer.

If each row of pallet in the trailer includes more than two pallet, the second pallet may be loaded similarly as the first pallet, except that the lateral side surface of the second pallet will be against a lateral side surface of the first pallet. In particular, after the first pallet is uploaded from the staging area onto the trailer, the robot 140 determines a pose of the first pallet. The robot 140 then exits the trailer and navigates to a second pallet in the staging area. The robot 140 picks up the second pallet and navigates to a third goal position within the trailer. The third goal position is determined based on the pose of the trailer and the pose of the first pallet. The robot 140 may navigates to a fourth goal position within the trailer. The fourth goal position is determined based on the pose of the trailer and the pose of the first pallet. The robot 140 side-shifts the fork toward a side of the first pallet until one or more sensors of the robot detects contact between a lateral side of the first pallet and a lateral side of the second pallet. The robot 140 may then side-shift the fork back away from the first pallet by a predetermined small distance to prevent the lateral sides of the first pallet and second pallet from scraping against each other during the second pallet's drop.

### Example Method for Loading Last X Rows of Pallets Onto Trailer

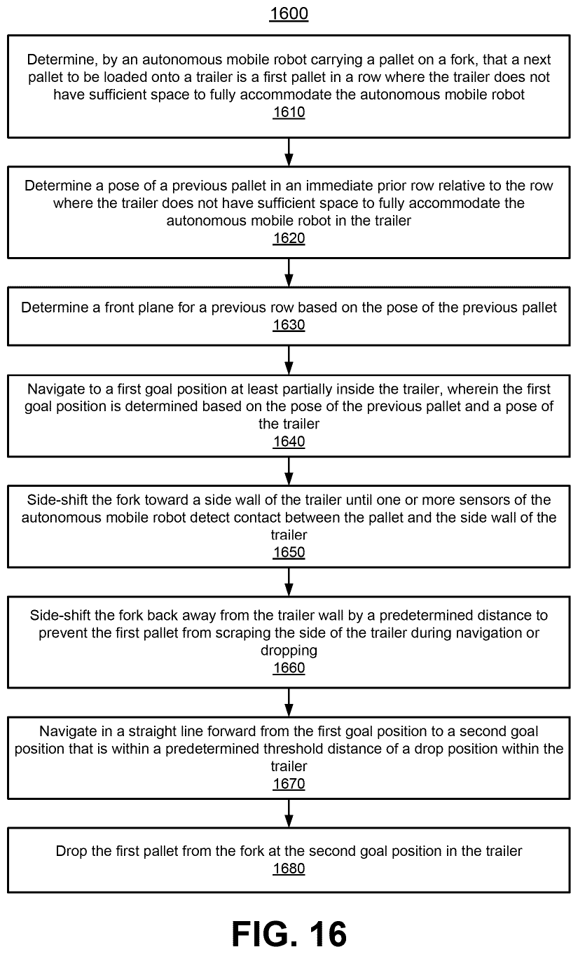

FIG. 16 is a flowchart of an example method 1600 for loading last X rows of pallets onto a trailer, in accordance with some embodiments. Alternative embodiments may include more, fewer, or different steps, and the steps may be performed in a different order from that illustrated in FIG. 16. Additionally, while FIG. 16 is primarily described in terms of actions taken by an autonomous mobile robot (e.g., robot 140), the steps may be performed, in part or in whole, by a central communication system in communication with an autonomous mobile robot.

The autonomous mobile robot 140 determines 1610 that a next pallet to be loaded onto a trailer is a first pallet in a row where the trailer does not have sufficient space to fully accommodate the autonomous mobile robot. The robot 140 determines 1620 a pose of a previous pallet in an immediate prior row relative to the row where the trailer does not have sufficient space to fully accommodate the autonomous mobile robot in the trailer. The robot 140 also determines 1630 a front plane for a previous row based on the pose of the previous pallet.

The robot 140 navigates 1640 to first goal position at least partially inside the trailer. the first goal position is determined based on the pose of the previous pallet and a pose of the trailer. After that, the robot 140 side-shifts 1650 the fork toward a side wall of the trailer until one or more sensors of the autonomous mobile robot detect contact between the pallet and the side wall of the trailer. The robot 140 then side-shifts 1660 the fork back away from the trailer wall by a predetermined distance to prevent the first pallet from scraping the side wall of the trailer during navigation or dropping. In some embodiments, the side wall of the trailer includes a lip along bottom of the side wall of the trailer. The lip of the side wall of the trailer is beneath the first pallet when the contact between the lateral side of the first pallet and the side wall of the trailer is detected. The predetermined distance that the fork side-shifts back is determined based on a width of the lip.

In some embodiments, the robot 140 determines a portion of the pallet that will be inside the trailer when the robot 140 reaches the first goal position. Responsive to determining that the portion of the first pallet inside the trailer is greater than a predetermined threshold (e.g., 25% of the total length of the pallet) the robot 140 side-shifts the fork toward the side wall of the trailer until one or more sensors of the autonomous mobile robot detects the contact between the pallet and the wall of the trailer. On the other hand, responsive to determining that the portion of the pallet inside the trailer is no greater than the predetermined threshold, the robot 140 shifts a position of the fork toward a side of a pallet pocket closer to the side wall of the trailer (as shown in FIG. 11) before side-shifting the fork toward the side wall of the trailer.

The robot 140 then navigates 1670 in a straight line forward from the first goal position to a second goal position that is within a predetermined threshold distance of a drop position within the trailer. The second goal position is determined based on the pose of the previous pallet and the pose of the trailer. Finally, the robot 140 drops 1680 the first pallet from the fork at the second goal position in the trailer. In some embodiments, the robot receives a project plan before performing the loading task. The project plan includes a plurality of pallets and a plurality of drop positions corresponding to the plurality of pallets.

In some embodiments, navigating to the second goal position includes navigating in straight line forward until detecting a contact between a front side of the first pallet and a back side of the previous pallet. Responsive to detecting the contact, the robot backs off a predetermined distance to prevent the front side of the first pallet from scraping the back side of the previous pallet during dropping of the first pallet.

### Example Method for Unloading Pallets from Trailer to Staging Area

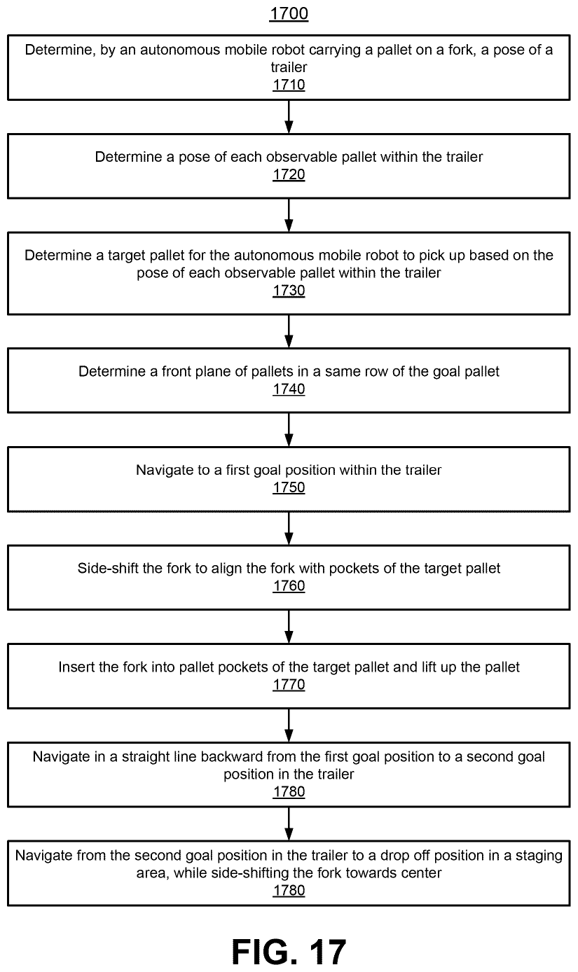

FIG. 17 is a flowchart of an example method 1700 for unloading pallets from a trailer to a staging area, in accordance with some embodiments. Alternative embodiments may include more, fewer, or different steps, and the steps may be performed in a different order from that illustrated in FIG. 17. Additionally, while FIG. 17 is primarily described in terms of actions taken by an autonomous mobile robot (e.g., robot 140), the steps may be performed, in part or in whole, by a central communication system in communication with an autonomous mobile robot.

The autonomous mobile robot 140 determines 1710 a pose of a trailer. The robot 140 also determines 1720 a pose of each observable pallet within the trailer. The autonomous mobile robot 140 determines 1730 a target pallet for pick up based on the pose of each observable pallet within the trailer. In some embodiments, the target pallet is a pallet that is the closest to a centerline of the trailer.

The autonomous mobile robot 140 determines 1740 a front plane of pallets in a same row of the target pallet. The front plane is a plane of a pallet in the same row that is closest to an entrance of the trailer. For example, the pallets in a same row may not be aligned perfectly. As illustrated in FIG. 14, the front plane is a plane of a pallet in the row that is closest to the entrance of the trailer.

The robot 140 navigate 1750 to a first goal position within the trailer. The first goal position is determined based on the pose of the target pallet and the pose of the trailer. The robot 140 side-shifts 1760 the fork to align the fork with pockets of the pallet, inserts 1770 the fork into pallet pockets of the target pallet. The autonomous mobile robot 140 navigates 1780 in a straight line backward from the first goal position to a second goal position in the trailer. The second goal position is determined based on the front plane of the pallet in the same row of the target pallet and the pose of the trailer. The autonomous mobile robot 140 navigates 1790 from the second goal position in the trailer to a drop off position in a staging area, while side-shifting the fork towards center.

In some embodiments, the robot 140 also determines that the first pallet is between a side wall of the trailer and a second pallet in the same row. The robot 140 determines a first distance between the first pallet and the side wall of the trailer and a second distance between the first pallet and the second pallet by one or more sensors. The robot 140 determines whether each of the first distance and the second distance is greater than a predetermined threshold. Responsive to determining that the first distance or the second distance is greater than the predetermined threshold, the robot 140 navigates in a straight line backward from the first goal position to the second goal position.

On the other hand, in response to determining that the first distance or the second distance is no greater than the predetermined threshold, the robot adjusts position of the first pallet to obtain maximum clearance from the side wall of the trailer. In some embodiments, adjusting position of the first pallet to obtain maximum clearance from the side wall of the trailer includes side-shifting the fork toward the second pallet until detecting a contact between a lateral side of the first pallet and a lateral side of the second pallet, and side-shift the fork back away from the second pallet by a predetermined distance to prevent the lateral side of the first pallet and the lateral side of the second pallet scraping against each other during navigation from the first goal position to the second goal position.

In some embodiments, the one or more sensors (which may be integrated with the fork) determines that the first pallet has moved more than a threshold distance relative to the fork during navigation from the first goal position to the second goal position. This may be caused by scraping against a trailer door or seal. Responsive to determining that the first pallet has moved more than a threshold distance, the robot 140 causes the autonomous mobile robot to stop and generate an alert.

### Example Method for Unloading First X Rows of Pallets from Trailer

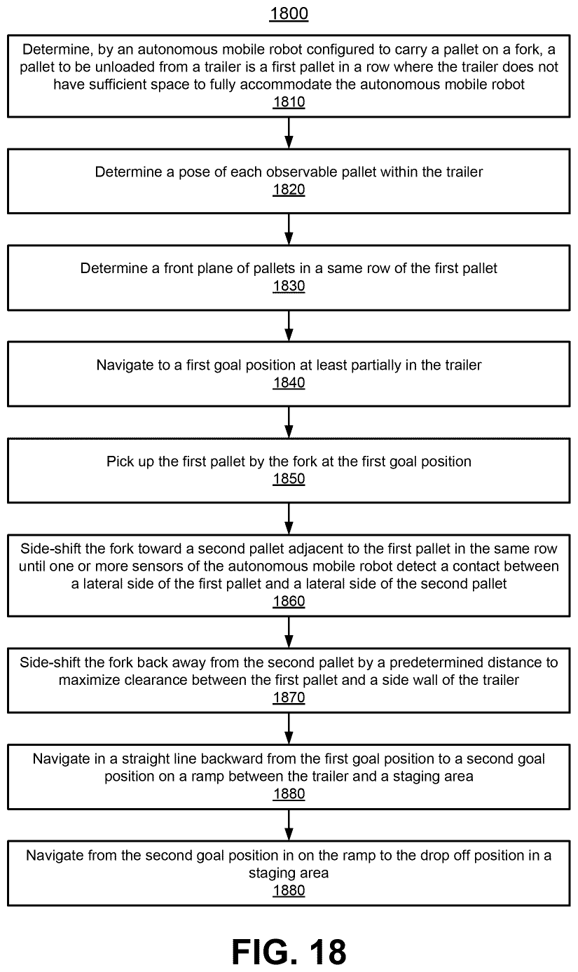

FIG. 18 is a flowchart of an example method 1800 for unloading first X rows of pallets from a trailer to a staging area, in accordance with some embodiments. Alternative embodiments may include more, fewer, or different steps, and the steps may be performed in a different order from that illustrated in FIG. 18. Additionally, while FIG. 18 is primarily described in terms of actions taken by an autonomous mobile robot (e.g., robot 140), the steps may be performed, in part or in whole, by a central communication system in communication with an autonomous mobile robot.

The autonomous mobile robot 140 determines 1810 a pallet to be unloaded from a trailer is a first pallet in a row where the trailer does not have sufficient space to fully accommodate the autonomous mobile robot. The robot 140 determines 1820 a pose of each observable pallet within the trailer. The robot 140 also determines 1830 a front plane of pallets in a same row of the first pallet. As illustrated in FIG. 10, the pallets in the same row may not be perfectly aligned, meaning the front plane of each pallet may not be flush with one another. The determined front plane of the pallets is a plane of a pallet in the same row that is closest to an entrance of the trailer. The robot 140 navigates 1840 to a first goal position at least partially in the trailer. The first goal position is determined based on the pose of the first pallet and the pose of the trailer.

The robot 140 picks up 1850 the first pallet by the fork at the first goal position. The robot 140 side-shifts 1860 the fork toward a second pallet adjacent to the first pallet in the same row until one or more sensors of the autonomous mobile robot detect a contact between a lateral side of the first pallet and a lateral side of the second pallet. The autonomous mobile robot 140 side-shifts 1870 the fork back away from the second pallet by a predetermined distance to maximize clearance between the first pallet and a side wall of the trailer.

The robot 140 then navigates 1880 in a straight line backward from the first goal position to a second goal position on a ramp between the trailer and a staging area. The second goal position is determined based on the front plane of pallets in the same row of the first pallet and the pose of the trailer. The autonomous mobile robot 140 navigates 1890 from the second goal position on the ramp to a drop off position in the staging area.

In some embodiments, the robot 140 side-shifts the fork to align the fork with pallet pockets of the first pallet before picking up the first pallet, and side-shifts the fork back to center during the navigation from the second goal position on the ramp to the drop off position in the staging area. In some embodiments, the robot 140 tilts the fork towards itself to stabilize the pallet during the navigation from the first goal position inside the trailer to the second goal position an the ramp, and/or from the second goal position on the ramp to the drop off position in the staging area.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated for the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method comprising:
determining, by an autonomous mobile robot carrying a first pallet on a fork, that a next pallet to be loaded onto a trailer is a first pallet in a row where the trailer does not have sufficient space to fully accommodate the autonomous mobile robot;
determining, by one or more sensors integrated with the autonomous mobile robot, a pose of a previous pallet in an immediate prior row relative to the row where the trailer does not have sufficient space to fully accommodate the autonomous mobile robot in the trailer;
determining a front plane for a previous row based on the pose of the previous pallet;
navigating to first goal position at least partially inside the trailer, wherein the first goal position is determined based on the pose of the previous pallet and a pose of the trailer;
side-shifting the fork toward a side wall of the trailer until one or more sensors of the autonomous mobile robot detect contact between the pallet and the side wall of the trailer;
side-shifting the fork back away from the trailer wall by a predetermined distance to prevent the first pallet from scraping the side wall of the trailer during navigation or dropping;
navigating in a straight line forward from the first goal position to a second goal position that is within a predetermined threshold distance of a drop position within the trailer, wherein the second goal position is determined based on the pose of the previous pallet and the pose of the trailer; and
dropping the first pallet from the fork at the second goal position in the trailer.

2. The method of claim 1, the method further comprising:
determining a portion of the pallet that will be inside the trailer when the autonomous mobile robot reaches the first goal position; and
responsive to determining that the portion of the first pallet inside the trailer is greater than a predetermined proportional threshold relative to a total size of the first pallet, side-shifting the fork toward the side wall of the trailer until one or more sensors of the autonomous mobile robot detect the contact between the pallet and the wall of the trailer.

3. The method of claim 2, the method further comprising:
responsive to determining that the portion of the pallet inside the trailer is not greater than the predetermined proportional threshold relative to the total size of the first pallet, causing the autonomous mobile robot to shift a position of the fork toward a side of a pallet pocket toward the side wall of the trailer before side-shifting the fork toward the side wall of the trailer.

4. The method of claim 1, wherein:
the side wall of the trailer includes a lip along a bottom of the side wall of the trailer, and
the lip of the side wall of the trailer is beneath the first pallet when the contact between a lateral side of the first pallet and the side wall of the trailer is detected, and
the predetermined distance that the fork side-shifts back is determined based on a width of the lip.

5. The method of claim 3, the method further comprising:
receiving a project plan, project plan including a plurality of pallets and a plurality of drop positions corresponding to the plurality of pallets.

6. The method of claim 1, wherein navigating to the second goal position includes:
navigating in straight line forward until detecting a contact between a front side of the first pallet and a back side of the previous pallet; and
backing off a predetermined distance to prevent the front side of the first pallet from scraping the back side of the previous pallet during dropping of the first pallet.

7. The method of claim 1, the method further comprising:
determining the fork extends beyond a side of first pallet by a distance;
dropping off the first pallet at the first goal position;
moving back for a predetermined distance that is greater than the determined distance that the fork extends beyond the first pallet's side; and
lifting the first pallet again before navigating to the second goal position.

8. The method of claim 1, the method further comprising:
determining a pose of the first pallet;
backing off the trailer;
picking up a second pallet from a staging area;
navigating to a third goal position within the trailer, wherein the third goal position is determined based on the pose of the first pallet and the pose of the trailer;
determining that a portion of the second pallet overlapping the first pallet is greater than a predetermined threshold;
side-shifting the fork toward a side of the first pallet until one or more sensors of the autonomous mobile robot detect contact between the side of the first pallet and a side of the second pallet;
side-shifting the fork back away from the first pallet by a second distance to prevent the first pallet and second pallet from scraping against each other during dropping of the second pallet;
navigating forward to a fourth goal position within the trailer that is within a predetermined threshold distance of a second drop position within the trailer, wherein the fourth goal position is determined based on the pose of the first pallet and the pose of the trailer; and
dropping the second pallet from the fork at the fourth goal position in the trailer.

9. The method of claim 1, the method further comprising:
determining, by the autonomous mobile robot, that a last pallet in a last row is to be loaded into a trailer,
determining a pose of a previous pallet in the last row and a pose of a visible pallet in an immediately preceding row in the trailer;
determining a front plane for the last row based on the pose of the previous pallet;
navigating the autonomous mobile robot to a third goal position, wherein the third goal position is determined based on the pose of the previous pallet, the pose of the visible pallet in the immediately preceding row, and the pose of the trailer;
positioning the fork to be on a side of a pallet pocket close to a second side wall of the trailer;
picking up the last pallet with the fork being on the side of the pallet pocket close to a second side wall of the trailer;
side-shifting the fork carrying the last pallet toward the second side wall of the trailer until the one or more sensors of the autonomous mobile robot detect contact between a lateral wall of the last pallet and the second side wall of the trailer;
navigating in a straight line to a second goal position that is within a predetermined threshold distance of a drop position within the trailer, wherein the second goal position is determined based on the pose of previous pallet, the pose of the visible pallet in the immediately preceding row in the trailer; and the pose of the trailer; and
dropping the first pallet from the fork at the second goal position in the trailer.

10. The method of claim 1, wherein the one or more sensors includes one or more of a 3D lidar, a stereo camera, a time-of-flight (TOF) sensor, an ultrasonic sensor, and an inertial measurement unit (IMU).

11. An autonomous mobile robot comprising:
a fork configured to carry a pallet stacked with a load;
one or more sensors;
one or more processors; and
a non-transitory computer-readable medium storing instructions that, when executed by the processor, cause the processor to perform steps comprising:
determining, by an autonomous mobile robot carrying a first pallet on a fork, that a next pallet to be loaded onto a trailer is a first pallet in a row where the trailer does not have sufficient space to fully accommodate the autonomous mobile robot;
determining, by one or more sensors integrated with the autonomous mobile robot, a pose of a previous pallet in an immediate prior row relative to the row where the trailer does not have sufficient space to fully accommodate the autonomous mobile robot in the trailer;
determining a front plane for a previous row based on the pose of the previous pallet;
navigating to first goal position at least partially inside the trailer, wherein the first goal position is determined based on the pose of the previous pallet and a pose of the trailer;
side-shifting the fork toward a side wall of the trailer until one or more sensors of the autonomous mobile robot detect contact between the pallet and the side wall of the trailer;
side-shifting the fork back away from the trailer wall by a predetermined distance to prevent the first pallet from scraping the side wall of the trailer during navigation or dropping;
navigating in a straight line forward from the first goal position to a second goal position that is within a predetermined threshold distance of a drop position within the trailer, wherein the second goal position is determined based on the pose of the previous pallet and the pose of the trailer; and
dropping the first pallet from the fork at the second goal position in the trailer.

12. The autonomous mobile robot of claim 11, the steps further comprising:
determining a portion of the pallet that will be inside the trailer when the autonomous mobile robot reaches the first goal position; and
responsive to determining that the portion of the first pallet inside the trailer is greater than a predetermined proportional threshold relative to a total size of the first pallet, side-shifting the fork toward the side wall of the trailer until one or more sensors of the autonomous mobile robot detect the contact between the pallet and the wall of the trailer.

13. The autonomous mobile robot of claim 12, the steps further comprising:
responsive to determining that the portion of the pallet inside the trailer is not greater than the predetermined proportional threshold relative to the total size of the first pallet, causing the autonomous mobile robot to shift a position of the fork toward a side of a pallet pocket toward the side wall of the trailer before side-shifting the fork toward the side wall of the trailer.

14. The autonomous mobile robot of claim 11, wherein:
the side wall of the trailer includes a lip along a bottom of the side wall,
the lip of the side wall of the trailer is beneath the first pallet when the contact between a lateral side of the first pallet and the side wall of the trailer is detected, and
the steps further comprises side-shifting the fork back away from the trailer wall by a distance corresponding to a width of the lip before navigating forward to the second goal position.

15. The autonomous mobile robot of claim 13, the steps further comprising:
receiving a project plan, project plan including a plurality of pallets and a plurality of drop positions corresponding to the plurality of pallets.

16. The autonomous mobile robot of claim 11, wherein navigating to the second goal position includes:
navigating in straight line forward until detecting a contact between a front side of the first pallet and a back side of the previous pallet; and
backing off a predetermined distance to prevent the front side of the first pallet from scraping the back side of the previous pallet during dropping of the first pallet.

17. The autonomous mobile robot of claim 11, the steps further comprising:
determining the fork extends beyond a side of first pallet by a distance;
dropping off the first pallet at the first goal position;
moving back for a predetermined distance that is greater than the determined distance that the fork extends beyond the first pallet's side; and
lifting the first pallet again before navigating to the second goal position.

18. The autonomous mobile robot of claim 11, the steps further comprising:
determining a pose of the first pallet;
backing off the trailer;
picking up a second pallet from a staging area;
navigating to a third goal position within the trailer, wherein the third goal position is determined based on the pose of the first pallet and the pose of the trailer;
determining that a portion of the second pallet overlapping the first pallet is greater than a predetermined threshold;
side-shifting the fork toward a side of the first pallet until one or more sensors of the autonomous mobile robot detect contact between the side of the first pallet and a side of the second pallet;
side-shifting the fork back away from the first pallet by a second distance to prevent the first pallet and second pallet from scraping against each other during dropping of the second pallet;
navigating forward to a fourth goal position within the trailer that is within a predetermined threshold distance of a second drop position within the trailer, wherein the fourth goal position is determined based on the pose of the first pallet and the pose of the trailer; and
dropping the second pallet from the fork at the fourth goal position in the trailer.

19. The autonomous mobile robot of claim 11, the steps further comprising:
determining, by the autonomous mobile robot, that a last pallet in a last row is to be loaded into a trailer,
determining a pose of a previous pallet in the last row and a pose of a visible pallet in an immediately preceding row in the trailer;
determining a front plane for the last row based on the pose of the previous pallet;
navigating the autonomous mobile robot to a third goal position, wherein the third goal position is determined based on the pose of the previous pallet, the pose of the visible pallet in the immediately preceding row, and the pose of the trailer;
positioning the fork to be on a side of a pallet pocket close to a second side wall of the trailer;
picking up the last pallet with the fork being on the side of the pallet pocket close to a second side wall of the trailer;
side-shifting the fork carrying the last pallet toward the second side wall of the trailer until the one or more sensors of the autonomous mobile robot detect contact between a lateral wall of the last pallet and the second side wall of the trailer;
navigating in a straight line to a second goal position that is within a predetermined threshold distance of a drop position within the trailer, wherein the second goal position is determined based on the pose of previous pallet, the pose of the visible pallet in the immediately preceding row in the trailer; and the pose of the trailer; and
dropping the first pallet from the fork at the second goal position in the trailer.

20. The autonomous mobile robot of claim 11, wherein the one or more sensors includes one or more of a 3D lidar, a stereo camera, a time-of-flight (TOF) sensor, an ultrasonic sensor, and an inertial measurement unit (IMU).
